(19) United States
(12) Patent Application Publication
(10) Pub. No.: US 2026/0254661 A1
(43) Pub. Date: Aug. 27, 2026

(54) Global Digital Sovereignty System Based on Domain-Tokenized Identity and Behavioral Certification

(71) Applicant: FURONG BEI, SAN GABRIEL, CA (US)

(72) Inventor: FURONG BEI, SAN GABRIEL, CA (US)

(21) Appl. No.: 19/177,585

(22) Filed: Apr. 13, 2025

(51) Int. Cl. H04L 9/32

(52) U.S. Cl. CPC H04L 9/3268; H04L 9/3213; H04L 9/3218

(57) ABSTRACT

A BEI domain-tokenized behavioral identity infrastructure is disclosed. A system receives a registration request for a domain, namespace, decentralized identity, registry, account, or other machine-resolvable identity-root identifier and generates a tokenized identity asset identifier from an identifier commitment, user identity anchor, and time-window value. A proof bundle including domain-control, identity-anchor, behavior, time-window, endpoint-control, or ledger-state proof is verified by a BEI behavioral certification engine under a policy container. A BEI signature module signs a payload including the identifier commitment, identity anchor, proof bundle, policy version, and ledger-state reference. An atomic registration or minting transition binds the asset to the identity anchor and generates a tokenized identity certificate, signed accounting receipt, and ledger entry. Signed receipts and certificate commitments are stored in a tamper-evident accounting ledger. Signed endpoint records route identity, wallet, minting, financial-service, audit, recovery, and policy-bounded rollback endpoints.

### TITLE AND CROSS-REFERENCE TO RELATED APPLICATIONS

This substitute specification is submitted for U.S. patent application Ser. No. 19/177,585 and is directed to BEI domain-tokenized behavioral identity infrastructure using proof bundles, signed accounting ledgers, policy-bounded rollback, and endpoint routing.

The disclosure is organized as a clean prosecution-oriented presentation of subject matter supported by the application materials, including domain-tokenized identity, behavioral certification, cryptographic verification, token metadata, wallet or communication identity use, security, lifecycle management, and related BEI infrastructure. No new matter is intended by the organization, terminology, or formatting of this substitute specification.

Related BEI ecosystem filings may address organic domain-token asset issuance, behavior-indexed token exchange, time-currency minting, clearinghouse settlement, identity anchors, endpoint records, rollback and recovery, wallet-bank endpoints, index systems, and associated financial or governance infrastructures. The present disclosure is directed to the BEI Domain Token root layer that may interoperate with such systems without requiring any one external system as a claim limitation.

The described invention is not limited to a conventional DNS domain name, a single blockchain, a particular token standard, a specific wallet, a specific exchange, a single identity provider, or any one jurisdictional framework. Domain names are important embodiments and root assets, while machine-resolvable identity-root identifiers may also include namespaces, decentralized identifiers, electronic identity identifiers, registry identifiers, account identifiers, credential identifiers, or equivalent identity-root records.

The BEI DomainToken root layer may support BEIMINT, BEI Currency, TimeCurrency, MF.app, ATMS financial-service endpoints, BEI index inputs, and exchange-listing preparation as examples of endpoint routing and asset-package use. Such examples illustrate technical integration and do not limit the scope unless expressly recited in a claim.

### TECHNICAL FIELD

The disclosure relates to computer-implemented identity-root registries, domain-tokenized identity assets, behavior-certified identity systems, proof-bundle verification, cryptographic signatures, time-window proofs, replay-prevention states, signed accounting receipts, tamper-evident accounting ledgers, signed endpoint records, and policy-bounded rollback.

More particularly, the disclosure relates to a BEI behavioral economic identity infrastructure in which a domain, namespace, decentralized identity, account, registry, or other identity-root identifier is converted into a tokenized identity asset that can be verified, certified, routed, audited, recertified, recovered, or boundedly rolled back under a machine-readable policy container.

The infrastructure may be implemented by centralized servers, distributed systems, permissioned ledgers, public ledgers, private databases, append-only logs, smart contracts, wallet applications, identity-provider services, financial-service endpoints, communication endpoints, or combinations thereof.

### BACKGROUND

Conventional domain-name systems generally treat domain names as human-readable routing labels rather than behavior-certified identity roots that carry proof bundles, accounting receipts, signed endpoint records, and rollback boundaries.

Conventional decentralized identity systems can represent identity identifiers or credential documents, but they do not ordinarily bind a domain or namespace identity root to a behavior proof, time-window proof, signed accounting receipt, tamper-evident accounting ledger, and policy-bounded rollback operation in a single ordered technical architecture.

Conventional token or non-fungible token systems can mint assets or metadata records. Such systems do not ordinarily verify a proof bundle through a behavioral certification engine, bind the proof to a validity window and replay-prevention state, and generate separate certificate, receipt, and ledger artifacts for bank-grade audit and recovery.

Conventional wallets and account systems can sign transactions, but they typically lack a multi-root identity graph that permits a person, family, organization, industry role, region, cultural role, medical or health role, numeric classification, time-based classification, or other identity root to route to distinct endpoints under a policy container.

Conventional financial systems use accounting ledgers and reversal procedures, but conventional distributed identity systems often do not provide policy-bounded rollback that is constrained by time windows, authority scope, proof requirements, ledger-state references, transaction boundaries, privacy boundaries, and policy-version identifiers.

Conventional security and authentication methods may verify credentials or device signatures, but they often fail to produce a complete audit trail connecting an identity-root identifier, behavior evidence, a time-window proof, a replay-prevention state, a BEI signature payload, a signed accounting receipt, and a signed endpoint record.

There is a need for a BEI technical infrastructure that converts domain-root and namespace-root identity resources into behavior-certified tokenized identity assets that are verifiable, auditable, interoperable, endpoint-routable, and recoverable under bounded policy controls.

There is also a need for a root identity infrastructure that can support commercial transfer, licensing, bank-grade integration, standard-protocol mapping, and asset-package diligence without requiring raw biometric data, raw behavior data, private-key material, or unredacted personally identifiable information to be exposed in ordinary verification.

### SUMMARY OF THE INVENTION

In one aspect, a computer-implemented method receives a registration request associated with a domain identifier, namespace identifier, decentralized identity identifier, registry identifier, account identifier, or other machine-resolvable identity-root identifier.

The method generates a tokenized identity asset identifier from an identifier commitment, a user identity anchor, and a time-window value. The identifier commitment may be a hash commitment, Merkle commitment, registry-record commitment, signed endpoint-record commitment, namespace commitment, or equivalent cryptographic commitment.

The method receives a proof bundle associated with a user. The proof bundle may include a domain-control proof, namespace-control proof, identity-anchor proof, behavior proof, time-window proof, endpoint-control proof, ledger-state proof, or evidence commitment from an authorized proof source.

A BEI behavioral certification engine verifies the proof bundle against a policy container. The policy container may define authorized proof sources, eligible behavior categories, jurisdictional rules, regulatory rules, standard-protocol mappings, validity windows, identity-root rules, privacy controls, recertification intervals, rollback boundaries, and endpoint roles.

A time-window proof binds an evidence commitment to a validity window and replay-prevention state. The replay-prevention state may include a nonce, counter, one-time commitment, session state, rate-limit state, prior ledger-state reference, challenge-response state, or duplicate-mint rejection state.

A BEI signature module signs a payload including at least an identifier commitment, user identity anchor, proof-bundle commitment, time-window value, policy-version identifier, and ledger-state reference.

An atomic registration or minting transition verifies, binds, registers, or mints the tokenized identity asset identifier to the user identity anchor and generates a tokenized identity certificate, signed accounting receipt, and ledger entry.

The signed accounting receipt and certificate commitment are stored in a tamper-evident accounting ledger. The ledger may be a distributed ledger, permissioned ledger, append-only log, Merkle log, timestamped receipt chain, accounting subledger, settlement ledger, audit ledger, write-once storage, or cryptographically auditable database.

A signed endpoint record routes the BEI behavior-certified tokenized identity asset to identity verification, proof verification, wallet, communication, minting, financial-service, exchange-listing, clearing, audit, governance, recovery, or policy-bounded rollback endpoints.

In another aspect, a policy-bounded rollback module freezes, restricts, reverses, revokes, restores, corrects, or recovers a tokenized identity asset state transition when a rollback request satisfies a rollback time window, authority scope, proof-bundle requirement, privacy boundary, and ledger-state reference.

### DEFINITIONS AND BEI STANDARD TERMS

BEI: means Behavioral Economic Identity or Behavioral Economics Identity, including a machine-verifiable identity framework that relates a user, organization, domain root, namespace root, behavior record, time window, proof bundle, certificate, receipt, ledger state, and endpoint role.
BEI DomainToken: means a tokenized identity asset generated from an identity-root identifier and bound to a user identity anchor, proof bundle, certificate, accounting receipt, ledger entry, endpoint record, or policy container.
Identity-root identifier: means a machine-resolvable identifier capable of serving as an identity root, including a domain, subdomain, namespace, DID, EID, account, registry record, credential identifier, or other structured root identifier.
Identifier commitment: means a cryptographic commitment, hash, Merkle root, registry commitment, signed endpoint-record commitment, namespace commitment, or reference that represents an identity-root identifier without requiring the identifier or all associated evidence to be exposed.
User identity anchor: means a verifiable binding to a user, account, device, public key, credential reference, biometric credential reference, account-bound token, domain-token identity root, or multi-root identity graph node.
Multi-root identity graph: means a data structure in which a user or entity may be associated with multiple identity roots, including personal, family, organization, country, regional, industry, cultural, health, medical, numeric, alphabet-based, time-based, or professional identity roots.
Proof bundle: means a machine-verifiable collection of proof commitments, signatures, references, source identifiers, time-window data, policy identifiers, and ledger-state references used to verify a tokenized identity asset operation.
Domain-control proof means a proof that a user or entity controls, is authorized to use, or is associated with a domain, subdomain, or domain-derived identifier. Namespace-control proof means an equivalent proof for a namespace identifier, registry namespace, organizational namespace, or application namespace.
Identity-anchor proof means a proof that a user identity anchor is controlled by, assigned to, or authorized for a user, organization, account, device, or credential subject. Behavior proof means a commitment, attestation, signed record, sensor-derived reference, or institutional proof associated with a behavior category, activity, interaction, health event, work event, education event, payment event, environmental event, or social attestation.
Time-window proof means a proof that binds evidence to a validity window, time interval, timestamp range, duration, calendar event, or TimeCurrency-related interval. Endpoint-control proof means a proof that a user or entity controls a wallet, application endpoint, communication endpoint, financial-service endpoint, minting endpoint, audit endpoint, or recovery endpoint.
Ledger-state proof means a proof or reference to a prior ledger state, receipt, certificate commitment, transaction state, or settlement state used to determine whether a new state transition is valid.
Authorized proof source means a source permitted by the policy container to provide evidence, including a device, sensor, secure element, institutional attestor, software agent, registry service, domain service, identity service, medical device, financial platform, or threshold group of verifiers.
BEI behavioral certification engine means a computer-implemented module configured to verify proof bundles, evidence commitments, behavior categories, source authorization, time windows, privacy conditions, and policy-container rules.
Policy container means a machine-readable collection of policy rules, standard-protocol mappings, jurisdictional rules, proof-source rules, privacy rules, endpoint-role rules, accounting rules, rollback rules, and interoperability rules.
Standard-protocol mapping means a mapping between BEI records and external or internal schemas, such as decentralized identity records, verifiable credentials, ledger entries, API objects, certificate schemas, receipt schemas, or endpoint records.
Replay-prevention state means a nonce, counter, one-time commitment, device-session state, rate-limit state, prior ledger-state reference, challenge-response state, or other state used to prevent duplicate or stale use of evidence.
BEI signature module means a module configured to generate or verify a cryptographic signature over an identifier commitment, identity anchor, proof bundle, time-window value, policy-version identifier, ledger-state reference, or endpoint-record reference.
Tokenized identity certificate means a certificate, credential, token metadata object, or certificate commitment identifying a tokenized identity asset, identifier commitment, identity anchor, proof-bundle commitment, time-window value, policy version, signature identifier, and ledger-state reference.
Signed accounting receipt means a signed event-level record for a registration, minting, recertification, endpoint update, freeze, transfer, clearing preparation, rollback, or recovery operation.
Tamper-evident accounting ledger means a ledger, log, database, subledger, settlement ledger, audit ledger, Merkle log, timestamped chain, or write-once store that supports detection of unauthorized alteration to certificate or receipt commitments.
Signed endpoint record means a signed routing record that identifies an endpoint role, endpoint address, public key, validity window, policy version, revocation state, jurisdiction identifier, priority, or failover endpoint.
Policy-bounded rollback means a rollback, reversal, freeze, restriction, correction, restoration, revocation, or recovery operation that is limited by a rollback time window, authority scope, proof-bundle requirement, ledger-state reference, privacy boundary, and policy version.
Authority scope means a policy-defined set of parties, devices, endpoints, keys, signatures, multi-signature thresholds, institutional roles, governance roles, or recovery authorities permitted to approve a state transition or rollback.
Privacy-preserving proof verification means proof verification using commitments, hashes, encrypted references, access-controlled records, redacted records, zero-knowledge proof references, or other methods that avoid exposing raw biometric data, raw behavior data, private-key material, or unnecessary personally identifiable information.
BEIMINT endpoint means an endpoint configured to receive verified identity and proof data for a behavior-currency or token minting operation. ATMS financial-service endpoint means a financial-service endpoint, wallet-bank endpoint, payment endpoint, account endpoint, or audit endpoint associated with ATMS-style banking or payment functionality.
Civilization economic infrastructure describes a class of interoperable identity, behavior, time, proof, ledger, currency, and endpoint systems that allow individuals and organizations to participate in verifiable digital economic activity. This term describes applicability and does not replace the technical limitations of the claims.

### BEI DOMAIN-ROOT IDENTITY ECOSYSTEM

In some embodiments, the BEI infrastructure may be deployed across a curated domain-root asset ecosystem in which domain names, namespaces, registry identifiers, application identifiers, or equivalent identity-root identifiers serve as independent roots of identity, wallet routing, proof verification, minting, communication, audit, recovery, or policy governance.

The ecosystem may include domain roots selected by category, country, region, industry, family, organization, personal interest, A-to-Z classification, numeric classification, cultural classification, medical or health classification, time segment, or other BEI classification. The claims are not limited to any particular number of domain roots or any particular list of domain names.

In some embodiments, a domain root may generate subordinate identity-token assets, such as subdomain identities, child identity tokens, endpoint tokens, wallet endpoints, site endpoints, terminal endpoints, or subordinate namespace identities. A subordinate identity root may inherit policy defaults from a parent root while maintaining its own proof bundle, signed endpoint record, accounting receipt, ledger entry, and rollback boundary.

A user may select multiple BEI identity roots based on personal identity, family identity, professional identity, industry role, regional role, health credential, cultural affiliation, numeric identifier, time-based role, or financial-service role. These roots may be represented in a multi-root identity graph.

The BEI Domain Token root layer may interoperate with BEIDID, BEIEID, BEIToken, BEIProof, BEIMINT, BEINFT, behavior-identity, domain-identity, and other identity, proof, token, minting, and endpoint services as examples of a broader BEI identity-root infrastructure.

The ecosystem may be used as a foundation for BEIECO, BEI.app, MF.app, ATMS, 24HWS, BEIMINT, BEI Currency, TimeCurrency, BEI index, BEIGX, BEIX, or other endpoints. These examples are implementation contexts and do not require a particular external brand, website, or endpoint to practice the claimed technical infrastructure.

### BEI STANDARD, PROTOCOL, AND POLICY CONTAINER LAYER

The policy container may operate as a BEI standardization and protocol layer. It maps identity-root rules, proof-source rules, endpoint-role rules, jurisdictional rules, privacy rules, accounting-ledger rules, rollback rules, and interoperability rules to machine-executable decisions.

An identity-root rule may specify whether a domain, namespace, DID, EID, account, registry identifier, or other identifier is eligible to serve as a root. A proof-source rule may specify which sensors, devices, secure elements, institutions, applications, registries, or threshold verifier groups may provide evidence.

An endpoint-role rule may specify which endpoints can verify proofs, route wallets, receive BEIMINT requests, receive TimeCurrency minting events, provide ATMS financial-service access, prepare exchange listings, perform clearing, export audit records, govern policies, or execute rollback operations.

A jurisdictional or regulatory rule may identify a privacy requirement, record retention requirement, recertification interval, transfer restriction, audit condition, or recovery standard applicable to a given endpoint, region, user role, or behavior category.

A standard-protocol mapping may express BEI records as JSON, XML, binary encoding, DID-compatible documents, verifiable credentials, API payloads, ledger events, smart-contract storage, database rows, or other machine-readable schema.

The protocol layer may support international interoperability and standardization. The BEI structures can be mapped to external identity, credential, wallet, ledger, financial-service, healthcare, education, or exchange systems without limiting the invention to any one external standard.

### NON-LIMITING DATA STRUCTURE EXAMPLES

In some embodiments, a proof bundle record includes fields such as proofBundleID, identityRootID, identifierCommitment, identity AnchorRef, proofSourceID, behaviorCategory, evidenceCommitment, timeWindow Value, replay StateRef, policy VersionID, endpointRecordHash, ledgerStateRef, privacyBoundaryCode, and proofSignatureRef.

In some embodiments, a signed accounting receipt includes fields such as receiptID, receiptType, tokenizedIdentity AssetID, priorLedgerStateRef, resultingLedgerStateRef, certificateCommitment, proofBundleCommitment, endpointRole, policy VersionID, timeWindow Value, authority ScopeID, rollback WindowID, signatureID, and auditExportRef.

In some embodiments, a tokenized identity certificate includes fields such as certificateID, tokenizedIdentity AssetID, identifierCommitmentRef, userIdentityAnchorRef, proofBundleCommitment, BEISignatureRef, validity Window, recertificationDue, endpointRecordRef, ledgerStateRef, statusCode, and revocationOrRecoveryRef.

In some embodiments, a signed endpoint record includes endpointRecordID, tokenizedIdentity AssetID, endpointRole, endpointAddress, endpointPublicKey, policy VersionID, jurisdictionID, validity Window, revocationStatus, keyRotationState, priority Value, failoverEndpoint, and external StandardMapping.

In some embodiments, a rollback policy schema includes rollbackPolicyID, permittedStateTypes, rollback Window, authority Scope, thresholdSignatureRule, proofBundleRequirement, privacyBoundary, maximumAmountOrScope, priorLedgerStateRequirement, reasonCodeSet, and auditExportRequirement.

The foregoing field lists are non-limiting examples. A practical implementation may use additional fields, fewer fields, encoded fields, or equivalent records while preserving the described technical relationships among identity-root identifiers, proof bundles, signatures, certificates, receipts, ledger states, endpoints, and rollback policies.

### BRIEF DESCRIPTION OF THE DRAWINGS

FIG. 1 illustrates an overall BEI domain-tokenized behavioral identity infrastructure including identity-root registration, proof-bundle verification, behavioral certification, time-window proof, signature generation, atomic minting or registration, accounting ledger storage, endpoint routing, and rollback control.

FIG. 2 illustrates an identity-root identifier registry including domain names, subdomains, namespaces, decentralized identifiers, electronic identifiers, account identifiers, registry identifiers, identifier commitments, identity-root rules, and eligibility states.

FIG. 3 illustrates a multi-root BEI identity graph including personal, family, industry, regional, health, cultural, numeric, and time-based identity roots.

FIG. 4 illustrates a tokenized identity asset generation flow including a registration request, identifier normalization, identifier commitment generation, identity-anchor binding, proof-bundle receipt, time-window verification, replay-state checking, atomic transition, and certificate or receipt issuance.

FIG. 5 illustrates a proof bundle architecture including domain-control proof, namespace-control proof, identity-anchor proof, behavior proof, time-window proof, endpoint-control proof, ledger-state proof, privacy boundary, and proof-bundle commitment.

FIG. 6 illustrates a BEI behavioral certification engine configured to validate proof bundles, authorized proof sources, evidence commitments, behavior categories, privacy boundaries, and certification outputs.

FIG. 7 illustrates a time-window proof and replay-prevention state machine including validity-window checking, nonce or counter validation, prior-state comparison, stale-proof rejection, duplicate-mint rejection, consumed states, and receipt issuance.

FIG. 8 illustrates a BEI signature payload including identifier commitment, identity anchor, proof-bundle commitment, time-window value, policy version, ledger-state reference, endpoint-record hash, and signed payload.

FIG. 9 illustrates a tokenized identity certificate and signed accounting receipt including certificate commitment, receipt type, prior ledger state, resulting ledger state, signature identifier, audit export, and ledger entry.

FIG. 10 illustrates a tamper-evident accounting ledger including certificate commitments, receipt commitments, append-only logs, Merkle logs, distributed or permissioned ledgers, accounting subledgers, settlement ledgers, audit ledgers, and tamper-evident output.

FIG. 11 illustrates signed endpoint records and endpoint routing for identity verification, wallet routing, communication routing, BEIMINT endpoints, financial-service endpoints, exchange-listing preparation, clearing, audit, recovery, and rollback.

FIG. 12 illustrates policy-bounded rollback and recovery including rollback requests, authority scope, rollback time window, proof-bundle requirement, ledger-state boundary, threshold authorization, privacy boundary, signed rollback receipts, and freeze, reverse, or restore actions.

FIG. 13 illustrates integration with BEIMINT, BEI Currency, TimeCurrency, ATMS financial-service endpoints, MF.app endpoints, BEI index input, and exchange-listing preparation.

FIG. 14 illustrates a BEI standard and protocol interoperability layer including BEI proof schema, certificate schema, accounting receipt schema, endpoint record schema, rollback policy schema, external DID, verifiable credential, API, and ledger standards, wallet-bank integration, registry-exchange integration, and interoperability output.

FIG. 15 illustrates an atomic registration and minting sequence including registration intake, endpoint-record resolution, proof-bundle verification, time-window checking, replay-state checking, payload signing, atomic mint-and-bind execution, ledger-entry writing, endpoint-record publication, and audit-reference return.

FIG. 16 illustrates example record schemas including proof bundle records, certificate records, accounting receipt records, endpoint records, rollback policy records, policy containers, ledger-state references, audit export records, and standard mapping records.

### OVERALL SYSTEM ARCHITECTURE

The BEI infrastructure may include a user device, identity-root registry, domain or namespace service, proof bundle engine, BEI behavioral certification engine, policy container service, time-window proof module, replay-prevention module, BEI signature module, minting and registration module, accounting ledger module, endpoint-record module, policy-bounded rollback module, and adapters for BEIMINT, BEI Currency, TimeCurrency, ATMS, MF.app, BEI index, or exchange-listing preparation.

The modules may be deployed on one server or distributed across devices, ledgers, registries, wallet systems, institutional systems, secure elements, cloud services, or edge systems. The technical architecture is not limited to a public blockchain and may use permissioned ledgers, private databases, append-only logs, smart contracts, or hybrid storage.

The identity-root registry stores eligible identifiers and associated metadata. The proof bundle engine collects and normalizes evidence commitments. The behavioral certification engine verifies proof requirements. The policy container service applies rules. The signature module signs verification results. The accounting ledger module generates receipts and ledger entries. The endpoint-record module routes certified identity assets to endpoint services.

A system may distinguish ownership, control, custody, endpoint use, audit access, authorization authority, recovery authority, and rollback authority. This distinction enables financial-service integration and reduces ambiguity in transactions, licensing, transfer, and audit.

### IDENTITY-ROOT REGISTRATION AND TOKENIZED IDENTITY ASSET GENERATION

A registration request may be received through a web interface, mobile application, domain registry interface, wallet interface, API, identity-provider service, institutional portal, or financial-service endpoint.

The system may normalize the identity-root identifier, determine eligibility under the policy container, generate an identifier commitment, and bind the identifier commitment to a user identity anchor and time-window value.

An identity root may be a domain name, subdomain, namespace, DID, EID, registry identifier, account identifier, or equivalent machine-resolvable root. The disclosed system uses identity-root language to avoid limiting the invention to conventional DNS while preserving domain names as important examples.

The tokenized identity asset identifier may be a token ID, credential ID, certificate ID, ledger key, wallet display field, endpoint record ID, or internal accounting identifier. The asset may be represented by a fungible token, non-fungible token, semi-fungible token, account-bound token, credential record, domain-derived asset record, or internal value unit.

The system may prevent duplicate identity-root claims by checking prior commitments, active certificates, revoked records, pending registrations, reservation records, namespace policies, or ledger-state references.

### PROOF BUNDLE ARCHITECTURE

A proof bundle may be generated before registration, during registration, during minting, during endpoint activation, during recertification, during audit, or during rollback.

The proof bundle may include domain-control proof, namespace-control proof, identity-anchor proof, behavior proof, time-window proof, endpoint-control proof, ledger-state proof, and source authorization data.

Proof evidence may be represented as raw evidence, hashed evidence, encrypted references, Merkle leaves, signed attestations, verifiable credential references, sensor-derived commitments, hardware secure element attestations, institutional attestations, or zero-knowledge proof references.

The proof bundle engine may compute a proof-bundle commitment over selected proof fields. The commitment may be signed by the BEI signature module or by an authorized proof source. The system may store the commitment rather than storing raw private data in the accounting ledger.

In some embodiments, raw biometric or behavior data is stored only by an authorized source or controlled evidence repository. The BEI ledger stores commitments, references, receipts, certificates, and audit codes rather than unnecessary private raw data.

A proof bundle may carry a privacy-boundary code that determines which data are visible to a user, wallet, bank, auditor, exchange, index system, governance reviewer, recovery authority, or public endpoint.

### BEI BEHAVIORAL CERTIFICATION ENGINE

The BEI behavioral certification engine verifies whether a proof bundle satisfies the policy container. It may verify source authorization, behavior category, identity-anchor association, validity window, replay-prevention state, endpoint role, and privacy boundary.

Behavior evidence may include biometric proof, location proof, time-engagement proof, interaction proof, health behavior proof, education behavior proof, work behavior proof, environmental behavior proof, payment behavior proof, or institutional attestation proof.

An authorized proof source may include a biometric sensor, geolocation sensor, secure element, institutional attestor, wallet, medical device, educational platform, employer system, financial platform, domain service, registry service, identity provider, or threshold verifier group.

The engine may produce a certification state, failure code, proof-source confidence value, behavior category decision, time-window decision, privacy decision, and ledger-ready output. The output can be signed and stored as part of a certificate commitment or accounting receipt.

Example failure codes may include source-not-authorized, proof-expired, identity-anchor-mismatch, replay-state-conflict, policy-version-invalid, endpoint-role-not-permitted, privacy-boundary-violation, and rollback-window-expired.

The engine may be configured to improve security by requiring a proof bundle to be verified under the policy container before the tokenized identity asset is minted, endpoint-routed, recertified, listed for exchange review, cleared, recovered, or rolled back.

### TIME-WINDOW PROOF AND REPLAY-PREVENTION STATE MACHINE

A time-window proof binds an evidence commitment to a validity window. The validity window may be an hour, day, week, month, year, event interval, service interval, recertification interval, TimeCurrency interval, or policy-defined time segment.

The replay-prevention state may include nonce, counter, session state, rate-limit state, one-time evidence commitment, prior ledger-state reference, or duplicate-mint rejection state. The state prevents a proof bundle or behavior evidence from being reused outside the permitted window or transaction context.

In an example sequence, the system receives an evidence commitment, checks the policy version, retrieves a prior ledger-state reference, verifies that the nonce or counter has not been used, verifies that the current time falls within the validity window, signs the result, and marks the replay-prevention state as consumed.

If a proof is stale, duplicated, outside the window, bound to the wrong endpoint role, or inconsistent with the prior ledger state, the system rejects the minting, endpoint update, clearing preparation, or rollback operation.

The state machine may include states such as pending, proof-received, source-verified, time-window-valid, replay-state-valid, signature-ready, atomic-transition-executed, receipt-issued, endpoint-active, recertification-required, frozen, reversed, restored, revoked, or recovered.

### BEI SIGNATURE MODULE

The BEI signature module generates or verifies a cryptographic signature over a signature payload. The payload may include identifier commitment, user identity anchor, proof-bundle commitment, time-window value, policy-version identifier, ledger-state reference, endpoint-record hash, replay-prevention state reference, and authorized source reference.

The signature algorithm is not limited to ECDSA, SHA-256, a specific blockchain key, or a particular key format. ECDSA, EdDSA, BLS, threshold signatures, hardware secure element signatures, institutional signatures, Merkle signatures, or equivalent cryptographic methods may be used.

The signature module may support key rotation, endpoint revocation, multi-signature authorization, threshold verification, institutional co-signing, recovery key use, and audit verification.

A signed result may be used to issue a tokenized identity certificate, generate a signed accounting receipt, publish or update an endpoint record, recertify an identity asset, or authorize a policy-bounded rollback operation.

The BEI signature module may sign a compact commitment rather than raw evidence, thereby improving privacy and supporting interoperability with external identity, credential, wallet, and ledger standards.

### ATOMIC MINTING AND REGISTRATION ENGINE

The atomic minting and registration engine may execute a single ordered transition that validates the identity root, verifies the proof bundle, checks the time-window proof, checks the replay-prevention state, signs a payload, binds the identity asset to the anchor, and issues certificate and receipt records.

Atomic execution may be implemented by a database transaction, smart contract transaction, two-phase commit, append-only log transaction, permissioned ledger transaction, or equivalent transactional mechanism.

If any required verification fails, the transition may abort and generate a failure receipt or error code without activating the endpoint record.

If the transition succeeds, the resulting ledger-state reference may be used by wallets, BEIMINT endpoints, financial-service endpoints, index systems, and exchange-listing preparation services.

Atomic execution reduces ambiguity because a tokenized identity asset is not treated as active unless the required verification, binding, certificate, receipt, and ledger steps have been completed.

The atomic transition is a key technical fence because a loose token or credential does not provide the same ordered verify-bind-receipt-ledger sequence.

### TOKENIZED IDENTITY CERTIFICATE, SIGNED ACCOUNTING RECEIPT, AND LEDGER ENTRY

The disclosed infrastructure separates a certificate, a receipt, and a ledger entry. This separation supports verification, audit, transfer, licensing, integration, and financial-service diligence.

The tokenized identity certificate represents the identity asset and may contain or reference the tokenized identity asset identifier, identifier commitment reference, user identity anchor reference, proof-bundle commitment, time-window value, policy-version identifier, signature identifier, ledger-state reference, status code, and certificate commitment.

The signed accounting receipt represents a specific event or state transition. It may be generated for registration, minting, recertification, endpoint update, wallet routing, BEIMINT operation, financial-service operation, exchange-listing preparation, freeze, rollback, recovery, or clearing preparation.

The ledger entry anchors the certificate commitment and receipt commitment in a tamper-evident accounting ledger. A ledger entry may include prior-state reference, resulting-state reference, event type, endpoint role, policy version, receipt hash, signature ID, time-window value, and audit export reference.

Using separate certificate and receipt artifacts improves auditability because the certificate identifies the asset, while each receipt identifies a transaction or state transition involving the asset.

This separation also supports licensing and transaction review because an assignee, licensee, financial institution, auditor, exchange, or governance reviewer can inspect certificates, receipts, endpoint records, and ledger-state references without requiring access to raw private evidence.

### TAMPER-EVIDENT ACCOUNTING LEDGER

The tamper-evident accounting ledger may be a distributed ledger, permissioned ledger, append-only log, Merkle log, timestamped receipt chain, cryptographically auditable database, accounting subledger, settlement ledger, audit ledger, or write-once storage.

The ledger stores signed accounting receipts, certificate commitments, endpoint-record commitments, rollback receipts, recertification receipts, audit references, and ledger-state references.

The ledger may support bank-grade audit by providing a deterministic trail from identity-root registration through proof verification, atomic transition, certificate issuance, receipt issuance, endpoint routing, recertification, and recovery or rollback.

The ledger is not required to store raw biometric data, raw behavior data, full private keys, or unredacted personally identifiable information. In many embodiments, it stores commitments, references, signatures, status codes, and audit hashes.

The ledger may provide exportable audit records for a bank, wallet provider, domain registry, exchange, institutional partner, assignee, licensee, or governance reviewer.

### SIGNED ENDPOINT RECORDS AND ENDPOINT ROUTING

A signed endpoint record routes the tokenized identity asset to one or more endpoint roles. The record may include endpoint address, endpoint role, public key, validity window, policy-version identifier, jurisdiction identifier, revocation state, key rotation state, priority value, failover endpoint, and external-standard mapping.

Endpoint roles may include identity verification, proof verification, policy retrieval, wallet routing, communication routing, BEIMINT operation, behavior-currency minting, TimeCurrency minting, BEI currency minting, ATMS financial-service access, MF.app use, BEI index input, exchange-listing preparation, clearing, audit, governance, recovery, or policy-bounded rollback.

Endpoint routing allows a BEI identity root to serve as a practical application layer rather than a static label. The endpoint record can be updated, revoked, rotated, or recovered under policy without invalidating the underlying identity-root identifier.

Endpoint routing may be implemented through domain records, application endpoints, DID documents, verifiable credential references, wallet APIs, ledger events, registry records, smart contract calls, communication endpoints, or financial-service APIs.

Before enabling a transaction, minting operation, wallet operation, endpoint update, exchange-listing preparation, clearing operation, or rollback request, the system may verify the endpoint record, policy version, public key, revocation state, and authority scope.

### POLICY-BOUNDED ROLLBACK AND RECOVERY

Policy-bounded rollback is a controlled operation that freezes, restricts, reverses, revokes, restores, corrects, or recovers a tokenized identity asset state transition only when policy-defined boundaries are satisfied.

The boundaries may include rollback time window, authority scope, proof-bundle requirement, ledger-state reference, transaction amount boundary, token-state type, nonce, counter, threshold authorization rule, privacy boundary, reason code, and policy-version identifier.

The rollback module may verify whether the requester is authorized, whether the rollback window remains open, whether the proof bundle satisfies the rollback policy, whether the prior ledger state matches the request, whether the transaction amount or scope is within the boundary, and whether privacy constraints are satisfied.

If the rollback request is approved, the module generates a signed rollback receipt, updates the token state, appends or commits the rollback receipt to the tamper-evident accounting ledger, and updates the signed endpoint record if required.

Rollback is not limited to email. Email, secure message, wallet challenge, institutional approval, hardware secure element confirmation, endpoint callback, multi-signature approval, or governance challenge may be used as optional confirmation channels.

Policy-bounded rollback improves the safety of financial-service endpoints because it provides a bounded correction mechanism rather than an unbounded reversal power. This supports banks, wallets, exchanges, auditors, and users while preserving deterministic auditability.

### PRIVACY AND SECURITY CONTROLS

Privacy-preserving proof verification may verify proof commitments, signatures, attestations, or ledger references without exposing raw biometric data, raw behavior data, private-key material, or unredacted personally identifiable information.

Privacy controls may include commitment storage, redaction, encryption, role-based access control, selective disclosure, zero-knowledge proof references, secure hardware attestation, threshold verification, audit permissioning, and data minimization.

Security controls may include key rotation, endpoint revocation, proof-source authorization, anomaly detection, duplicate rejection, stale proof rejection, challenge-response verification, multi-signature rollback, bounded recovery, and audit export.

For example, a privacy-preserving rollback proof can show that a rollback condition is satisfied without disclosing raw evidence. The ledger may store the rollback receipt, policy version, reason code, and proof commitment rather than the underlying private data.

The system may be configured so that different endpoint roles receive different views of the same identity asset. A wallet may see a certificate status, a bank may see an accounting receipt and audit status, an exchange may see listing preparation fields, and a governance reviewer may see policy compliance fields.

### HARDWARE AND SECURE ELEMENT EMBODIMENTS

In some embodiments, an authorized proof source includes a hardware secure element that signs a challenge or attests that a key is protected by a device-controlled execution environment.

A biometric sensor may produce a biometric credential reference or commitment rather than raw biometric data. The commitment may be verified by the BEI behavioral certification engine under the policy container.

A geolocation sensor, medical device, payment terminal, educational device, or institutional device may provide signed evidence that is bound to a time-window proof and replay-prevention state.

Hardware-based proof can strengthen the practical application of the system by linking the software identity infrastructure to physical-world proof sources.

A secure element signature may be combined with a user wallet signature and institutional attestation to satisfy a threshold proof-source rule.

The system is not limited to hardware proof, but hardware proof embodiments demonstrate concrete technical implementation and can support regulated financial-service use cases.

### CROSS-CHAIN AND CROSS-PLATFORM EMBODIMENTS

The BEI infrastructure may operate across multiple ledgers, chains, databases, registries, wallets, identity providers, or financial-service platforms.

A ledger-state reference may identify a chain transaction, permissioned ledger entry, database commitment, append-only log record, or hybrid reference.

A signed endpoint record may route a tokenized identity asset to a public blockchain wallet, private bank ledger, registry API, DID resolver, or domain service.

Cross-platform operation may be controlled by a standard-protocol mapping so that equivalent certificate, receipt, endpoint, and rollback fields are interpreted consistently across systems.

When an asset moves from one platform to another, the system may generate a transfer or interoperability receipt that links the prior ledger-state reference to a resulting-state reference.

This cross-platform architecture supports long-term value by permitting the BEI identity-root infrastructure to remain useful as external standards and platforms evolve.

### EXCHANGE-LISTING AND CLEARING PREPARATION

Exchange-listing preparation may require the tokenized identity asset to provide certificate status, proof-bundle commitment, signed accounting receipt history, endpoint record status, policy version, and audit export references.

A clearing preparation endpoint may verify whether the asset has valid identity proof, current recertification, permitted endpoint roles, no unresolved rollback state, and appropriate ledger-state references.

An exchange or index system may use endpoint records and accounting receipts to determine whether a BEI identity asset is ready for listing review, index input, or clearing workflow.

The present disclosure does not need to claim the full exchange system to provide value. It provides the identity, proof, receipt, ledger, and endpoint artifacts that exchange and clearing systems can consume.

When an exchange-listing preparation event occurs, the system may generate a listing-preparation receipt and store it in the accounting ledger.

This structure supports an exchange layer by providing verifiable assets that can be routed into a behavior-indexed exchange or index ecosystem.

### ATOMIC TRANSITION AND SEQUENCE EXAMPLES

In a non-limiting registration sequence, the system receives a registration request, normalizes the identity-root identifier, generates an identifier commitment, associates a user identity anchor, receives a proof bundle, verifies source authorization, verifies the time-window proof, verifies the replay-prevention state, signs the payload, executes the atomic transition, issues a certificate, issues a signed accounting receipt, stores ledger commitments, and publishes an endpoint record.

In a non-limiting BEIMINT sequence, the system receives a minting request at a BEIMINT endpoint, verifies the signed endpoint record, obtains a proof bundle commitment, checks the policy container, verifies a time-window proof, checks replay state, signs a mint payload, executes an atomic mint-and-bind transition, stores a signed accounting receipt, and returns a ledger-state reference to the endpoint.

In a non-limiting financial-service sequence, an ATMS financial-service endpoint receives an identity assertion, requests a signed endpoint record, verifies the certificate commitment, verifies a recent accounting receipt, checks revocation and recertification status, applies jurisdictional policy rules, and either enables the financial-service operation or requests additional proof.

In a non-limiting rollback sequence, the system receives a rollback request, identifies the target state transition, retrieves the prior ledger-state reference, verifies authority scope, verifies the rollback proof bundle, verifies the rollback window, verifies privacy boundary, applies threshold authorization if required, generates a signed rollback receipt, updates the asset state, and records the result in the accounting ledger.

In pseudocode form, an operation may perform: resolve identity root; validate policy; verify proof bundle; check time window; check replay state; sign payload; execute atomic transition; issue certificate; issue receipt; write ledger entry; publish endpoint record; and, if requested, execute bounded rollback only when all rollback boundaries pass.

### BEIMINT, BEI CURRENCY, TIMECURRENCY, MF.APP, AND ATMS USE CASES

A BEIMINT endpoint may use the tokenized identity asset as an identity key for behavior-currency minting. The proof bundle and time-window proof establish the user, behavior category, endpoint authority, policy version, and ledger-state reference used for the minting operation.

A TimeCurrency endpoint may use time-window proof values and proof-bundle commitments to mint, route, audit, or recertify time-denominated value units under a policy container.

A BEI Currency endpoint may use the identity certificate, signed accounting receipt, and endpoint record to route behavior-certified value, wallet state, recertification status, and recovery boundaries.

An MF.app endpoint may provide user-facing enrollment, proof submission, certificate display, wallet routing, endpoint management, recertification prompts, and recovery operations.

An ATMS financial-service endpoint may use the tokenized identity asset as a wallet-bank identity root. The signed accounting ledger supports audit, settlement preparation, financial-service access, recovery, and policy-bounded rollback.

A BEI index input or exchange-listing preparation endpoint may consume signed certificates, receipts, ledger references, endpoint records, and proof-bundle commitments to prepare an asset for index computation, diligence, audit, listing review, or clearing preparation.

These endpoint use cases are practical applications that integrate the identity-root infrastructure into wallet, banking, minting, index, exchange, audit, and recovery environments.

### STANDARDIZATION AND INTEROPERABILITY EMBODIMENTS

The BEI standard layer may define interoperable schemas for identity-root identifiers, proof bundles, tokenized identity certificates, signed accounting receipts, ledger entries, signed endpoint records, policy containers, rollback policies, and audit exports.

Schemas may be expressed as JSON, XML, binary encoding, verifiable credential records, decentralized identity documents, smart-contract events, API objects, ledger records, database records, or other machine-readable formats.

The infrastructure may interoperate with external DID, verifiable credential, wallet, ledger, domain-registry, financial-service, healthcare credential, education credential, exchange, and governance standards.

The standard-protocol mapping allows BEI records to be adopted as protocol-compatible artifacts without limiting the claims to any one standard body or any one version of an external standard.

Interoperability supports licensing and deployment because wallets, banks, registries, identity providers, exchanges, and enterprise systems can integrate the BEI root layer through endpoint records and protocol schemas.

### EXAMPLES AND APPLICATIONS

Example 1: An individual BEI Domain Token identity root is generated from a personal namespace and bound to a user identity anchor. A proof bundle is verified, a tokenized identity certificate is issued, and a wallet endpoint is activated.

Example 2: A family namespace serves as a family identity root. Subordinate identity-token assets inherit family policy defaults while maintaining separate proof bundles, endpoint records, certificates, receipts, and rollback boundaries.

Example 3: A medical or health identity root uses an institutional proof source to verify a professional credential or health-related behavior category. The ledger stores commitments and receipts while protecting raw private data.

Example 4: A country or regional identity root is combined with an industry identity root to route an asset to jurisdiction-specific endpoint policies and audit rules.

Example 5: An A-to-Z or numeric identity root is used as a readable classification root for a set of subordinate wallet, communication, and minting endpoints.

Example 6: A BEIMINT event uses a time-window proof, behavior proof, and replay-prevention state to mint a behavior-currency value under a policy container.

Example 7: An ATMS financial-service endpoint verifies the tokenized identity certificate, recent receipt, endpoint record, and policy version before enabling wallet-bank access.

Example 8: A suspicious endpoint update triggers policy-bounded rollback. The rollback module verifies authority scope, proof bundle, ledger-state reference, and privacy boundary, then signs and records a rollback receipt.

Example 9: An exchange-listing preparation endpoint requests certificate status, proof-bundle commitment, accounting receipts, endpoint roles, and audit export references before listing review.

Example 10: A BEI standard mapping converts a proof bundle, certificate, signed accounting receipt, and endpoint record into an external API payload for a wallet, registry, bank, or credential provider.

### DETAILED ENABLEMENT AND EXAMINER-RESILIENT IMPLEMENTATION EXAMPLES

The following implementation examples are provided to strengthen the technical disclosure and to show how the BEI domain-tokenized behavioral identity infrastructure may be practiced using concrete computer modules, data structures, state transitions, and verification routines. The examples are non-limiting and may be combined, omitted, substituted, or rearranged without departing from the disclosed architecture.

The examples are written to emphasize practical application rather than abstract organization. Each example connects an identity-root identifier, a proof bundle, a BEI behavioral certification engine, a time-window proof, a replay-prevention state, a BEI signature, an atomic registration or minting transition, a signed accounting receipt, a tamper-evident accounting ledger, a signed endpoint record, and a policy-bounded rollback rule.

The architecture is intentionally not limited to a single token standard, a single chain, a single DNS registry, a single DID method, a single biometric sensor, or a single financial institution. It may be deployed through conventional servers, cloud services, wallet software, smart contracts, hardware secure elements, permissioned ledgers, append-only logs, or hybrid systems.

### EXAMPLE IDENTITY-ROOT REGISTRATION FLOW

A registration service receives a human-readable identity-root identifier and normalizes it according to a selected policy container. Normalization may include case folding, Unicode handling, punycode handling, namespace-prefix validation, restricted-character checks, reserved-word screening, jurisdictional eligibility checks, and duplicate-root checks.

The registration service generates an identifier commitment from the normalized identity-root identifier. The commitment may be a hash, a Merkle leaf, a registry object reference, a signed namespace record, or a composite commitment that includes a namespace class, a jurisdiction tag, and a policy-version value.

The user identity anchor is obtained from a wallet, account, DID document, electronic identity credential, domain-token identity root, device key, institutional credential, or multi-root identity graph node. The anchor does not need to expose raw personal data if the proof bundle contains a commitment or verification reference.

A policy container determines whether the identity-root identifier can be registered by the requesting subject. The policy may test proof-source authorization, domain-control proof, account-control proof, family or organization authorization, health or professional credential references, or regional eligibility.

After successful validation, the registration module performs a single atomic transition that writes a registration state, tokenized identity asset identifier, certificate commitment, signed accounting receipt, endpoint record reference, and ledger-state reference. If any required verification fails, the transition aborts without partially minting or partially binding the asset.

The system returns a result code indicating registered, pending, rejected, duplicate, stale proof, insufficient authority, invalid source, invalid signature, expired time-window, or rollback-required. The result code can be used by wallet, audit, financial-service, or recovery endpoints without exposing raw evidence.

### PROOF BUNDLE GENERATION AND VALIDATION DETAILS

A domain-control proof may be generated by publishing a challenge in a DNS record, signing a challenge using a domain-associated key, presenting a registry authorization record, or providing a signed endpoint record that links a domain basepoint to a BEI identity anchor. The proof may be stored as a commitment rather than raw registrar data.

In one non-limiting implementation, the domain-control proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

A namespace-control proof may be generated by a registry service, a parent namespace operator, a family or organization administrator, or a jurisdictional namespace authority. The proof indicates that the subject is authorized to create or operate a sub-basepoint, subdomain, derived identifier, or subordinate identity node.

In one non-limiting implementation, the namespace-control proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

An identity-anchor proof may include a DID authentication, verifiable credential presentation, account-bound token check, public-key challenge response, biometric credential reference, or institutional attestation. The raw credential may remain off-ledger while a commitment and verification state are included in the proof bundle.

In one non-limiting implementation, the identity-anchor proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

A behavior proof may include a time-engagement record, transaction record, health behavior record, educational behavior record, work contribution record, environmental contribution record, payment record, attendance record, social attestation, or institutional confirmation. The proof may be signed by an authorized proof source designated in the policy container.

In one non-limiting implementation, the behavior proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

A time-window proof binds an evidence commitment to a bounded time interval. It may include a timestamp, epoch, sliding window, session identifier, duration value, TimeCurrency interval, calendar event, nonce, counter, and policy effective-time value so that stale or duplicated evidence cannot be reused.

In one non-limiting implementation, the time-window proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

An endpoint-control proof demonstrates that an endpoint address, service URL, API gateway, wallet address, messaging endpoint, BEIMINT endpoint, ATMS endpoint, audit endpoint, recovery endpoint, or clearing endpoint is controlled by or authorized for the tokenized identity asset.

In one non-limiting implementation, the endpoint-control proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

A ledger-state proof references a prior ledger entry, receipt chain, Merkle root, certificate commitment, settlement state, freeze state, rollback state, or recovery state. The state reference prevents an attacker from replaying a previously valid proof after the ledger state has changed.

In one non-limiting implementation, the ledger-state proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

A privacy-preserving proof may show that a record satisfies a policy condition without exposing raw biometric data, raw behavior data, full legal identity data, private-key material, or unredacted personally identifiable information. The proof may be implemented using commitments, encrypted references, access-controlled records, zero-knowledge proof references, or redacted attestations.

In one non-limiting implementation, the privacy proof is represented by a proof type code, issuer key identifier, evidence commitment, validity window, policy-version identifier, source authorization reference, signature value, and optional redaction or privacy flag. These fields permit deterministic verification while allowing the underlying evidence to remain under controlled access.

### BEI BEHAVIORAL CERTIFICATION ENGINE-VERIFICATION ROUTINE

The BEI behavioral certification engine may perform a sequence of computer checks. A first check confirms that the proof source is included in a signed policy container or is delegated by an authorized endpoint record. A second check validates the digital signature and verifies that the key has not been revoked or rotated outside the relevant validity window.

A third check evaluates whether the behavior category is eligible for the requested identity-root role, minting operation, financial-service endpoint, or exchange-listing preparation. A fourth check confirms that the evidence commitment corresponds to the proof bundle and is not already consumed by a prior ledger-state transition.

A fifth check verifies the time-window proof. The engine may reject the proof if the validity window is expired, if the time value precedes the policy effective time, if the source clock is outside tolerance, if the session state is inconsistent, or if the proof conflicts with a previous ledger-state reference.

A sixth check evaluates anomaly thresholds, including velocity, geographic inconsistency, device inconsistency, proof-density anomaly, issuer reputation, duplicate root attempts, or suspicious clustering across multiple identity roots. The engine may output approved, pending review, restricted, frozen, denied, or rollback-required states.

The engine output may include a certification state, certification score, proof-bundle commitment, policy-version identifier, verification time, result code, and audit reference. The output may be signed by the BEI signature module or by a hardware-backed key in a secure element or trusted execution environment.

An implementation may use a result code such as APPROVED, indicating that all required proof checks passed. Result codes may be recorded in signed accounting receipts and used by endpoint records for audit, recovery, exchange-listing preparation, or financial-service routing.

An implementation may use a result code such as PENDING, indicating that manual or institutional review is required. Result codes may be recorded in signed accounting receipts and used by endpoint records for audit, recovery, exchange-listing preparation, or financial-service routing.

An implementation may use a result code such as DENIED_SOURCE, indicating that proof source is not authorized. Result codes may be recorded in signed accounting receipts and used by endpoint records for audit, recovery, exchange-listing preparation, or financial-service routing.

An implementation may use a result code such as DENIED_TIME, indicating that validity window or replay-prevention check failed. Result codes may be recorded in signed accounting receipts and used by endpoint records for audit, recovery, exchange-listing preparation, or financial-service routing.

An implementation may use a result code such as DENIED_SIG, indicating that signature or key status failed. Result codes may be recorded in signed accounting receipts and used by endpoint records for audit, recovery, exchange-listing preparation, or financial-service routing.

An implementation may use a result code such as DENIED_POLICY, indicating that policy container rule failed. Result codes may be recorded in signed accounting receipts and used by endpoint records for audit, recovery, exchange-listing preparation, or financial-service routing.

An implementation may use a result code such as FROZEN, indicating that asset or endpoint state is frozen. Result codes may be recorded in signed accounting receipts and used by endpoint records for audit, recovery, exchange-listing preparation, or financial-service routing.

An implementation may use a result code such as ROLLBACK_REQUIRED, indicating that a prior state transition must be reversed, corrected, restricted, or recovered. Result codes may be recorded in signed accounting receipts and used by endpoint records for audit, recovery, exchange-listing preparation, or financial-service routing.

### TIME-WINDOW PROOF AND REPLAY-PREVENTION STATE MACHINE

The state machine may include a REQUESTED state. In that state, the system stores a state identifier, time-window value, prior ledger-state reference, proof-bundle commitment, policy-version identifier, and transition guard. A transition out of the REQUESTED state occurs only when the applicable proof, signature, policy, and replay-prevention guard are satisfied.

The state machine may include a SOURCE_SIGNED state. In that state, the system stores a state identifier, time-window value, prior ledger-state reference, proof-bundle commitment, policy-version identifier, and transition guard. A transition out of the SOURCE_SIGNED state occurs only when the applicable proof, signature, policy, and replay-prevention guard are satisfied.

The state machine may include a WINDOW_OPEN state. In that state, the system stores a state identifier, time-window value, prior ledger-state reference, proof-bundle commitment, policy-version identifier, and transition guard. A transition out of the WINDOW_OPEN state occurs only when the applicable proof, signature, policy, and replay-prevention guard are satisfied.

The state machine may include a PROOF_VERIFIED state. In that state, the system stores a state identifier, time-window value, prior ledger-state reference, proof-bundle commitment, policy-version identifier, and transition guard. A transition out of the PROOF_VERIFIED state occurs only when the applicable proof, signature, policy, and replay-prevention guard are satisfied.

The state machine may include a NONCE_CONSUMED state. In that state, the system stores a state identifier, time-window value, prior ledger-state reference, proof-bundle commitment, policy-version identifier, and transition guard. A transition out of the NONCE_CONSUMED state occurs only when the applicable proof, signature, policy, and replay-prevention guard are satisfied.

The state machine may include a COMMITMENT_LOCKED state. In that state, the system stores a state identifier, time-window value, prior ledger-state reference, proof-bundle commitment, policy-version identifier, and transition guard. A transition out of the COMMITMENT_LOCKED state occurs only when the applicable proof, signature, policy, and replay-prevention guard are satisfied.

The state machine may include a ATOMIC_TRANSITION_PENDING state. In that state, the system stores a state identifier, time-window value, prior ledger-state reference, proof-bundle commitment, policy-version identifier, and transition guard. A transition out of the ATOMIC_TRANSITION_PENDING state occurs only when the applicable proof, signature, policy, and replay-prevention guard are satisfied.

The state machine may include a REGISTERED_OR_MINTED state. In that state, the system stores a state identifier, time-window value, prior ledger-state reference, proof-bundle commitment, policy-version identifier, and transition guard. A transition out of the REGISTERED_OR_MINTED state occurs only when the applicable proof, signature, policy, and replay-prevention guard are satisfied.

The state machine may include a RECEIPT_ANCHORED state. In that state, the system stores a state identifier, time-window value, prior ledger-state reference, proof-bundle commitment, policy-version identifier, and transition guard. A transition out of the RECEIPT_ANCHORED state occurs only when the applicable proof, signature, policy, and replay-prevention guard are satisfied.

The state machine may include a ENDPOINT_ROUTED state. In that state, the system stores a state identifier, time-window value, prior ledger-state reference, proof-bundle commitment, policy-version identifier, and transition guard. A transition out of the ENDPOINT_ROUTED state occurs only when the applicable proof, signature, policy, and replay-prevention guard are satisfied.

The state machine may include a WINDOW_EXPIRED state. In that state, the system stores a state identifier, time-window value, prior ledger-state reference, proof-bundle commitment, policy-version identifier, and transition guard. A transition out of the WINDOW_EXPIRED state occurs only when the applicable proof, signature, policy, and replay-prevention guard are satisfied.

The state machine may include a REPLAY_REJECTED state. In that state, the system stores a state identifier, time-window value, prior ledger-state reference, proof-bundle commitment, policy-version identifier, and transition guard. A transition out of the REPLAY_REJECTED state occurs only when the applicable proof, signature, policy, and replay-prevention guard are satisfied.

The state machine may include a ROLLBACK_PENDING state. In that state, the system stores a state identifier, time-window value, prior ledger-state reference, proof-bundle commitment, policy-version identifier, and transition guard. A transition out of the ROLLBACK_PENDING state occurs only when the applicable proof, signature, policy, and replay-prevention guard are satisfied.

The state machine may include a ROLLBACK_COMPLETED state. In that state, the system stores a state identifier, time-window value, prior ledger-state reference, proof-bundle commitment, policy-version identifier, and transition guard. A transition out of the ROLLBACK_COMPLETED state occurs only when the applicable proof, signature, policy, and replay-prevention guard are satisfied.

A nonce may be generated per registration request, per proof source, per user session, per endpoint role, per identity-root identifier, or per time-window. Once the nonce is consumed by a successful atomic transition, a subsequent attempt to reuse the same nonce can be rejected as a replay attempt.

A counter may be maintained per identity anchor, domain root, proof source, endpoint role, or minting category. The counter may be incremented only upon successful state transition, so that an attacker cannot reorder proof bundles or use stale evidence in a later validity window.

A one-time evidence commitment may be marked consumed after minting or registration. If the same evidence commitment is presented for a second asset, a second currency mint, or a second endpoint activation, the system may deny the request, quarantine the request, or require an institutional override recorded as a signed accounting receipt.

Rate-limit state may restrict the number of registration, minting, recertification, endpoint update, transfer preparation, or rollback requests that can occur within a policy-defined interval. The rate limit may be different for personal nodes, family nodes, organization nodes, industry nodes, health nodes, regional nodes, and financial-service endpoints.

### BEI SIGNATURE PAYLOAD AND KEY MANAGEMENT

The BEI signature payload may include a identifierCommitment field. The field can be concatenated, encoded, hashed, or otherwise canonicalized before signature generation, enabling independent verifiers to reconstruct the payload and verify the signature without relying on an unstructured textual description.

The BEI signature payload may include a identity AnchorReference field. The field can be concatenated, encoded, hashed, or otherwise canonicalized before signature generation, enabling independent verifiers to reconstruct the payload and verify the signature without relying on an unstructured textual description.

The BEI signature payload may include a proofBundleCommitment field. The field can be concatenated, encoded, hashed, or otherwise canonicalized before signature generation, enabling independent verifiers to reconstruct the payload and verify the signature without relying on an unstructured textual description.

The BEI signature payload may include a timeWindow Value field. The field can be concatenated, encoded, hashed, or otherwise canonicalized before signature generation, enabling independent verifiers to reconstruct the payload and verify the signature without relying on an unstructured textual description.

The BEI signature payload may include a policy VersionIdentifier field. The field can be concatenated, encoded, hashed, or otherwise canonicalized before signature generation, enabling independent verifiers to reconstruct the payload and verify the signature without relying on an unstructured textual description.

The BEI signature payload may include a ledgerStateReference field. The field can be concatenated, encoded, hashed, or otherwise canonicalized before signature generation, enabling independent verifiers to reconstruct the payload and verify the signature without relying on an unstructured textual description.

The BEI signature payload may include a endpointRecordHash field. The field can be concatenated, encoded, hashed, or otherwise canonicalized before signature generation, enabling independent verifiers to reconstruct the payload and verify the signature without relying on an unstructured textual description.

The BEI signature payload may include a nonceOrCounter field. The field can be concatenated, encoded, hashed, or otherwise canonicalized before signature generation, enabling independent verifiers to reconstruct the payload and verify the signature without relying on an unstructured textual description.

The BEI signature payload may include a issuerOrSourceReference field. The field can be concatenated, encoded, hashed, or otherwise canonicalized before signature generation, enabling independent verifiers to reconstruct the payload and verify the signature without relying on an unstructured textual description.

The BEI signature payload may include a rollbackBoundaryReference field. The field can be concatenated, encoded, hashed, or otherwise canonicalized before signature generation, enabling independent verifiers to reconstruct the payload and verify the signature without relying on an unstructured textual description.

The BEI signature payload may include a privacyFlag field. The field can be concatenated, encoded, hashed, or otherwise canonicalized before signature generation, enabling independent verifiers to reconstruct the payload and verify the signature without relying on an unstructured textual description.

The BEI signature payload may include a standardProtocolMapping field. The field can be concatenated, encoded, hashed, or otherwise canonicalized before signature generation, enabling independent verifiers to reconstruct the payload and verify the signature without relying on an unstructured textual description.

The signature module may use any suitable cryptographic signature algorithm, including elliptic-curve signatures, post-quantum or quantum-resistant signatures, threshold signatures, multi-signature policies, institutional signatures, hardware-secure-element signatures, or future standard-compliant signatures. The claims are not limited to any single signature family.

Key rotation may be handled by a signed endpoint record indicating a prior public key, new public key, validity window, revocation state, and ledger-state reference. A key rotation may require proof of authority scope, a time-window proof, and a signed accounting receipt so that prior certificates and receipts remain auditable.

A compromised key may trigger a policy-bounded recovery process. The system may freeze selected endpoint roles, restrict financial-service access, require recertification, issue a recovery challenge, and append a signed recovery receipt to the tamper-evident accounting ledger.

### SIGNED ACCOUNTING RECEIPT AND LEDGER ENTRY DATA STRUCTURES

A signed accounting receipt may include a receiptID field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a receiptType field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a tokenizedIdentity AssetID field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a identityRootID field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a identifierCommitment field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a proofBundleCommitment field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a certificateCommitment field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a priorLedgerStateReference field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a resultingLedgerStateReference field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a policy VersionIdentifier field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a time Window Value field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a signatureIdentifier field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a endpointRole field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a operationCode field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a reasonCode field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a privacyFlag field. The field supports traceability of registration, minting, transfer preparation, endpoint update, recertification, freeze, restriction, rollback, restoration, recovery, clearing preparation, or audit operations while preserving a machine-readable event history.

A signed accounting receipt may include a auditReference field. The field supports traceability of registration, minting, transfer preparation, endpoint update, recertification, freeze, restriction, rollback, restoration, recovery, clearing preparation, or audit operations while preserving a machine-readable event history.

A ledger entry may store the signed accounting receipt, a receipt hash, a certificate commitment, a prior-state pointer, a resulting-state pointer, a time anchor, and a policy-version identifier. The ledger entry may be stored in a distributed ledger, permissioned ledger, append-only log, Merkle log, WORM store, cryptographically auditable database, accounting subledger, settlement ledger, or audit ledger.

The ledger is called an accounting ledger because it records state transitions in a manner that can support debit, credit, mint, freeze, revoke, restore, transfer preparation, exchange-listing preparation, clearing, and settlement events. The ledger does not need to be a legal bank ledger in every embodiment; it is a computer-implemented auditable ledger used by BEI endpoint services.

The certificate, receipt, and ledger operate as three separate but linked layers. The certificate states the existence and current certified identity status of the tokenized identity asset. The receipt records an event-level operation. The ledger stores the receipt and commitment trail so that auditors, assignees, licensees, financial institutions, or recovery authorities can verify the history.

A diligence export may include selected certificates, signed accounting receipts, ledger-state proofs, endpoint records, policy-version histories, and rollback receipts. The export may be used for licensing, assignment, transfer, financial-service integration, or asset-package review without revealing raw private evidence.

### POLICY CONTAINER MACHINE-READABLE RULE EXAMPLES

A policy container may include a authorizedProofSources element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a eligibleBehaviorCategories element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a identityRootRules element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a endpointRoleRules element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a jurisdictionRules element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a privacyRules element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a recertificationIntervals element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a mintingCaps element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a rateLimits element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a anomaly Thresholds element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a freezeConditions element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a rollbackConditions element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a authority Scopes element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a standardProtocolMappings element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a auditPermissions element. The element can be expressed as a rule table, JSON object, XML object, smart-contract storage object, database row, policy document, or signed binary encoding. The element may be versioned and signed so that a verifier can determine which policy was effective at the time of a state transition.

A policy container may include a effectiveTimeWindows element. The element can be expressed as a rule table, JSON object, XML object, smart-contract storage object, database row, policy document, or signed binary encoding. The element may be versioned and signed so that a verifier can determine which policy was effective at the time of a state transition.

The policy container may include default rules inherited from a parent domain root and override rules for a subordinate subdomain, family node, organization node, industry node, regional node, health node, financial-service node, or exchange-listing node. Inheritance may be limited by a policy boundary so that local nodes cannot remove required privacy, audit, or rollback controls.

A policy container may map BEI data structures to external standards, including DID-compatible identity documents, verifiable credential schemas, JSON APIs, XML schemas, ISO-style settlement messages, wallet interfaces, registry records, or clearinghouse formats. Such mappings support interoperability without limiting the invention to any particular standards body.

The policy container may encode a non-discrimination or open integration profile, such as a fair, reasonable, interoperable, and non-discriminatory integration profile. Such a profile may define minimum verification, privacy, audit, and endpoint routing requirements for licensees or third-party implementers.

### SIGNED ENDPOINT RECORDS AND ROUTABLE SERVICE DISCOVERY

A signed endpoint record may define a identity verification endpoint role. The record may include endpoint address, protocol type, public key, certificate reference, policy-version identifier, validity window, revocation status, jurisdiction tag, failover endpoint, and service priority for that role.

A signed endpoint record may define a proof verification endpoint role. The record may include endpoint address, protocol type, public key, certificate reference, policy-version identifier, validity window, revocation status, jurisdiction tag, failover endpoint, and service priority for that role.

A signed endpoint record may define a policy retrieval endpoint role. The record may include endpoint address, protocol type, public key, certificate reference, policy-version identifier, validity window, revocation status, jurisdiction tag, failover endpoint, and service priority for that role.

A signed endpoint record may define a wallet routing endpoint role. The record may include endpoint address, protocol type, public key, certificate reference, policy-version identifier, validity window, revocation status, jurisdiction tag, failover endpoint, and service priority for that role.

A signed endpoint record may define a communication routing endpoint role. The record may include endpoint address, protocol type, public key, certificate reference, policy-version identifier, validity window, revocation status, jurisdiction tag, failover endpoint, and service priority for that role.

A signed endpoint record may define a behavior-currency minting endpoint role. The record may include endpoint address, protocol type, public key, certificate reference, policy-version identifier, validity window, revocation status, jurisdiction tag, failover endpoint, and service priority for that role.

A signed endpoint record may define a TimeCurrency minting endpoint role. The record may include endpoint address, protocol type, public key, certificate reference, policy-version identifier, validity window, revocation status, jurisdiction tag, failover endpoint, and service priority for that role.

A signed endpoint record may define a BEI Currency minting endpoint role. The record may include endpoint address, protocol type, public key, certificate reference, policy-version identifier, validity window, revocation status, jurisdiction tag, failover endpoint, and service priority for that role.

A signed endpoint record may define a BEIMINT operation endpoint role. The record may include endpoint address, protocol type, public key, certificate reference, policy-version identifier, validity window, revocation status, jurisdiction tag, failover endpoint, and service priority for that role.

A signed endpoint record may define a ATMS financial-service access endpoint role. The record may include endpoint address, protocol type, public key, certificate reference, policy-version identifier, validity window, revocation status, jurisdiction tag, failover endpoint, and service priority for that role.

A signed endpoint record may define a MF.app endpoint access endpoint role. The record may include endpoint address, protocol type, public key, certificate reference, policy-version identifier, validity window, revocation status, jurisdiction tag, failover endpoint, and service priority for that role.

A signed endpoint record may define a BEI index input endpoint role. The record may include endpoint address, protocol type, public key, certificate reference, policy-version identifier, validity window, revocation status, jurisdiction tag, failover endpoint, and service priority for that role.

A signed endpoint record may define a exchange-listing preparation endpoint role. The record may include endpoint address, protocol type, public key, certificate reference, policy-version identifier, validity window, revocation status, jurisdiction tag, failover endpoint, and service priority for that role.

A signed endpoint record may define a clearing endpoint role. The record may include endpoint address, protocol type, public key, certificate reference, policy-version identifier, validity window, revocation status, jurisdiction tag, failover endpoint, and service priority for that role.

A signed endpoint record may define a audit endpoint role. The record may include endpoint address, protocol type, public key, certificate reference, policy-version identifier, validity window, revocation status, jurisdiction tag, failover endpoint, and service priority for that role.

A signed endpoint record may define a governance endpoint role. The record may include endpoint address, protocol type, public key, certificate reference, policy-version identifier, validity window, revocation status, jurisdiction tag, failover endpoint, and service priority for that role.

A signed endpoint record may define a recovery endpoint role. The record may include endpoint address, protocol type, public key, certificate reference, policy-version identifier, validity window, revocation status, jurisdiction tag, failover endpoint, and service priority for that role.

A signed endpoint record may define a policy-bounded rollback endpoint role. The record may include endpoint address, protocol type, public key, certificate reference, policy-version identifier, validity window, revocation status, jurisdiction tag, failover endpoint, and service priority for that role.

Endpoint records may be published through DNS records, DNSSEC-protected records, DANE or TLSA-style bindings, DID documents, registry APIs, wallet metadata, distributed ledger records, content-addressed storage, or other machine-resolvable namespace records. The invention is not limited to any one publication mechanism.

For population-scale deployments, a hierarchical routing scheme may map sub-basepoints into regional gateways, sector gateways, institutional gateways, service meshes, and edge endpoints. The routing scheme permits a user device to discover a local proof endpoint, wallet endpoint, policy endpoint, minting endpoint, clearing endpoint, or recovery endpoint using a signed endpoint record.

In a hotspot-like service discovery embodiment, a local device or service may broadcast a short code or beacon corresponding to a domain or subdomain hash fragment. A mobile device resolves the fragment to a signed endpoint record and obtains the current policy bundle, local service endpoint, and clearing gateway while verifying the endpoint signature and validity window.

The endpoint routing layer improves technical operation by reducing stale routing, preventing spoofed endpoints, binding services to identity roots, allowing failover with cryptographic verification, and giving auditors a deterministic path from an identity-root identifier to proof, minting, ledger, rollback, and clearing services.

### POLICY-BOUNDED ROLLBACK, RECOVERY, AND CORRECTION

A policy-bounded rollback operation may be limited by a rollback time window. The limitation prevents arbitrary ledger editing and converts rollback into a controlled, auditable state transition that produces a signed rollback receipt and a new ledger entry.

A policy-bounded rollback operation may be limited by a authority scope. The limitation prevents arbitrary ledger editing and converts rollback into a controlled, auditable state transition that produces a signed rollback receipt and a new ledger entry.

A policy-bounded rollback operation may be limited by a transaction amount boundary. The limitation prevents arbitrary ledger editing and converts rollback into a controlled, auditable state transition that produces a signed rollback receipt and a new ledger entry.

A policy-bounded rollback operation may be limited by a token-state type. The limitation prevents arbitrary ledger editing and converts rollback into a controlled, auditable state transition that produces a signed rollback receipt and a new ledger entry.

A policy-bounded rollback operation may be limited by a prior ledger-state reference. The limitation prevents arbitrary ledger editing and converts rollback into a controlled, auditable state transition that produces a signed rollback receipt and a new ledger entry.

A policy-bounded rollback operation may be limited by a proof-bundle requirement. The limitation prevents arbitrary ledger editing and converts rollback into a controlled, auditable state transition that produces a signed rollback receipt and a new ledger entry.

A policy-bounded rollback operation may be limited by a multi-signature threshold. The limitation prevents arbitrary ledger editing and converts rollback into a controlled, auditable state transition that produces a signed rollback receipt and a new ledger entry.

A policy-bounded rollback operation may be limited by a institutional approval rule. The limitation prevents arbitrary ledger editing and converts rollback into a controlled, auditable state transition that produces a signed rollback receipt and a new ledger entry.

A policy-bounded rollback operation may be limited by a jurisdictional rule. The limitation prevents arbitrary ledger editing and converts rollback into a controlled, auditable state transition that produces a signed rollback receipt and a new ledger entry.

A policy-bounded rollback operation may be limited by a privacy rule. The limitation prevents arbitrary ledger editing and converts rollback into a controlled, auditable state transition that produces a signed rollback receipt and a new ledger entry.

A policy-bounded rollback operation may be limited by a reason code. The limitation prevents arbitrary ledger editing and converts rollback into a controlled, auditable state transition that produces a signed rollback receipt and a new ledger entry.

A policy-bounded rollback operation may be limited by a exposure cap. The limitation prevents arbitrary ledger editing and converts rollback into a controlled, auditable state transition that produces a signed rollback receipt and a new ledger entry.

In a fraud example, an identity-root identifier is compromised after a valid minting event. The policy-bounded rollback module freezes the affected endpoint roles, verifies an identity-anchor proof and authority scope, generates a signed rollback receipt, and updates the token state to restricted or recovered without exposing raw biometric data.

In a duplicate-mint example, the replay-prevention module detects that the same evidence commitment was consumed in a prior validity window. The rollback module may reverse the later minting state, append a rollback receipt, preserve the earlier valid receipt, and mark the later request with a duplicate-mint reason code.

In a financial-service error example, an ATMS endpoint receives an invalid endpoint update or transfer preparation request. The system checks the rollback window, authority scope, ledger-state reference, and proof-bundle requirement before correcting or restoring the endpoint record.

In an institutional dispute example, a healthcare, education, employer, or registry source withdraws or corrects an attestation. The system records a correction receipt, updates the certificate commitment, preserves the prior receipt chain, and marks the affected endpoint or minting capacity according to the policy container.

In a privacy recovery example, the system verifies a redacted proof or zero-knowledge proof reference that a user satisfies recovery conditions. The signed rollback or recovery receipt indicates compliance with the policy without recording raw identity or behavioral details in the public ledger state.

The rollback operation may be described as BEI policy-bounded rollback, BEI bounded recovery, BEI bounded reversal, BEI forced and fair rollback, or BEI correction. These terms denote a constrained technical state transition, not an arbitrary business cancellation.

### HARDWARE, SENSOR, AND SECURE ELEMENT IMPLEMENTATIONS

An authorized proof source may include a hardware secure element. In that implementation, the source signs evidence or an evidence commitment using a key registered in the policy container or endpoint record, and the BEI behavioral certification engine verifies the source authorization before accepting the proof bundle.

An authorized proof source may include a trusted execution environment. In that implementation, the source signs evidence or an evidence commitment using a key registered in the policy container or endpoint record, and the BEI behavioral certification engine verifies the source authorization before accepting the proof bundle.

An authorized proof source may include a biometric sensor. In that implementation, the source signs evidence or an evidence commitment using a key registered in the policy container or endpoint record, and the BEI behavioral certification engine verifies the source authorization before accepting the proof bundle.

An authorized proof source may include a geolocation sensor. In that implementation, the source signs evidence or an evidence commitment using a key registered in the policy container or endpoint record, and the BEI behavioral certification engine verifies the source authorization before accepting the proof bundle.

An authorized proof source may include a medical device. In that implementation, the source signs evidence or an evidence commitment using a key registered in the policy container or endpoint record, and the BEI behavioral certification engine verifies the source authorization before accepting the proof bundle.

An authorized proof source may include a Internet-of-Things device. In that implementation, the source signs evidence or an evidence commitment using a key registered in the policy container or endpoint record, and the BEI behavioral certification engine verifies the source authorization before accepting the proof bundle.

An authorized proof source may include a payment terminal. In that implementation, the source signs evidence or an evidence commitment using a key registered in the policy container or endpoint record, and the BEI behavioral certification engine verifies the source authorization before accepting the proof bundle.

An authorized proof source may include a mobile phone secure enclave. In that implementation, the source signs evidence or an evidence commitment using a key registered in the policy container or endpoint record, and the BEI behavioral certification engine verifies the source authorization before accepting the proof bundle.

An authorized proof source may include a hardware security module. In that implementation, the source signs evidence or an evidence commitment using a key registered in the policy container or endpoint record, and the BEI behavioral certification engine verifies the source authorization before accepting the proof bundle.

An authorized proof source may include a institutional signing server. In that implementation, the source signs evidence or an evidence commitment using a key registered in the policy container or endpoint record, and the BEI behavioral certification engine verifies the source authorization before accepting the proof bundle.

An authorized proof source may include a edge gateway. In that implementation, the source signs evidence or an evidence commitment using a key registered in the policy container or endpoint record, and the BEI behavioral certification engine verifies the source authorization before accepting the proof bundle.

An authorized proof source may include a auditable oracle. In that implementation, the source signs evidence or an evidence commitment using a key registered in the policy container or endpoint record, and the BEI behavioral certification engine verifies the source authorization before accepting the proof bundle.

A secure element may store a private key used for challenge-response, endpoint update approval, mint request approval, or rollback authorization. The private key need not be exported; instead, the secure element signs canonical payloads that include nonce, time-window value, identifier commitment, proof-bundle commitment, and policy-version identifier.

A sensor proof may be represented by a measurement commitment, device identifier, calibration state, timestamp, source signature, and privacy flag. Raw sensor data can remain off-ledger or under controlled access while the commitment and signed proof state support audit, verification, and dispute resolution.

A hardware-backed embodiment strengthens the practical application of the invention by tying abstract identity and proof data to concrete devices, sensors, secure key stores, and verifiable machine operations. The system remains operable without hardware in other embodiments, but hardware sources provide additional assurance where required.

### BEI DOMAIN ROOT, TREASURE-BOWL RESOURCE LAYER, AND VIRGIN-LAND EXPANSION LAYER

In some embodiments, the BEI domain-root ecosystem includes a curated collection of domain names, application domains, namespace labels, registry labels, and derived identifiers developed over a long horizon. Each such resource can function as a basepoint for identity, proof, wallet, minting, clearing, governance, audit, recovery, and endpoint routing.

The term Treasure-Bowl resource layer may denote a reusable, extensible reservoir of routable basepoints and sub-basepoints. The phrase is used as a technical metaphor for scalable addressability and discoverability, not as a limitation on claim scope or as a mere brand label.

The term Virgin-Land expansion layer may denote the ability to create new sub-basepoints, subdomains, derived identifiers, subordinate identity nodes, functional nodes, endpoint tokens, wallet endpoints, site endpoints, terminal endpoints, or child identity roots under policy-controlled rules.

A single identity-root identifier may serve as a root for a personal node, family node, organization node, country node, regional node, industry node, medical or health node, cultural node, A-to-Z node, numeric node, time-based node, or governance node. The implementation can therefore support multiple identities for a single user without requiring that all identity roles collapse into one monolithic identifier.

The BEI infrastructure is not limited to any particular set of domain names. Specific BEI-controlled domains, application domains, or namespace identifiers may be used as examples of endpoints, but equivalent domains, DIDs, EIDs, accounts, registry records, machine-resolvable identifiers, or future standard identifiers can be substituted.

The domain-root layer can interoperate with identity systems such as BEIDID, BEIEID, DRIDX, BEIProof, BEIToken, BEIMINT, BEINFT, BEI Wallet, BEI Index, BEIGX, BEIX, ATMS, MF.app, 24HWS, or other endpoint families. These names are implementation examples and do not limit the technical mechanisms described in the claims.

### BEIMINT, BEI CURRENCY, TIMECURRENCY, AND FINANCIAL-SERVICE ENDPOINT EXAMPLES

A BEIMINT endpoint receives a proof-bundle commitment, BEI signature, time-window proof, and ledger-state reference. The endpoint verifies that the tokenized identity asset is current and then determines whether a behavior-currency minting request is permitted under the policy container.

The BEIMINT identity key example demonstrates how the BEI DomainToken root layer acts as a choke-point for identity, proof, endpoint routing, ledger receipts, and bounded recovery before the downstream service can safely rely on the user state.

A BEI Currency endpoint may use the verified identity root, behavior proof, time-window proof, and signed accounting receipt to generate or update a BEI currency state. The currency operation can be restricted by minting caps, source authorization, endpoint roles, replay-prevention state, and rollback boundaries.

The BEI Currency minting example demonstrates how the BEI Domain Token root layer acts as a choke-point for identity, proof, endpoint routing, ledger receipts, and bounded recovery before the downstream service can safely rely on the user state.

A TimeCurrency endpoint may receive a time-engagement proof or time-window proof and convert a verified time interval into a time-denominated credit, point, token, certificate, or ledger state. The system may bind the minted unit to an identity anchor and preserve a receipt trail.

The TimeCurrency minting example demonstrates how the BEI DomainToken root layer acts as a choke-point for identity, proof, endpoint routing, ledger receipts, and bounded recovery before the downstream service can safely rely on the user state.

An ATMS financial-service endpoint may use the tokenized identity certificate and endpoint record to route wallet-bank access, payment initiation, account recovery, proof verification, audit, and clearing preparation. The endpoint can require signed receipts and ledger-state references for regulated operations.

The ATMS financial-service access example demonstrates how the BEI DomainToken root layer acts as a choke-point for identity, proof, endpoint routing, ledger receipts, and bounded recovery before the downstream service can safely rely on the user state.

An MF.app endpoint may use the multi-root identity graph to select a personal, family, professional, health, region, or industry identity root for a user interaction. The endpoint may present only the minimum proof necessary for a given transaction or service role.

The MF.app identity endpoint example demonstrates how the BEI DomainToken root layer acts as a choke-point for identity, proof, endpoint routing, ledger receipts, and bounded recovery before the downstream service can safely rely on the user state.

A BEI Index endpoint may receive redacted or aggregated proof states, signed accounting receipts, behavior categories, and policy-version identifiers to compute an index input without requiring raw private evidence. The endpoint can reject stale or duplicated receipt inputs.

The BEI Index input example demonstrates how the BEI DomainToken root layer acts as a choke-point for identity, proof, endpoint routing, ledger receipts, and bounded recovery before the downstream service can safely rely on the user state.

An exchange-listing preparation endpoint may verify the identity-root certificate, proof-bundle history, endpoint record, ledger-state proof, recertification status, and rollback status before a tokenized identity asset or associated value unit is eligible for listing or clearing.

The Exchange-listing preparation example demonstrates how the BEI DomainToken root layer acts as a choke-point for identity, proof, endpoint routing, ledger receipts, and bounded recovery before the downstream service can safely rely on the user state.

A medical, health, educational, professional, or licensing endpoint may verify an identity-anchor proof and institutional attestation. The endpoint may produce a signed accounting receipt showing that a credential was verified, recertified, restricted, or corrected under a policy container.

The Healthcare or professional identity example demonstrates how the BEI DomainToken root layer acts as a choke-point for identity, proof, endpoint routing, ledger receipts, and bounded recovery before the downstream service can safely rely on the user state.

### CROSS-PLATFORM, CROSS-CHAIN, AND CLEARINGHOUSE INTEROPERABILITY

The invention can operate across heterogeneous systems by separating identifier commitments, proof-bundle commitments, signed receipts, endpoint records, and ledger-state references from the particular storage or transport system used to carry them. A record may be stored on one ledger, while detailed evidence is retained in a permissioned database and endpoint records are published through domain or registry infrastructure.

An interoperability adapter may translate BEI records into external message formats. For example, a signed accounting receipt can be mapped into an audit message, a settlement message, a verifiable credential, an API payload, a registry entry, or a financial-service event without changing the underlying receipt commitment.

A clearinghouse embodiment may receive tokenized identity certificate references, proof-bundle commitments, endpoint records, and ledger-state proofs before matching, netting, settlement instruction generation, reconciliation, or exception handling. The clearinghouse may reject an item if the relevant endpoint record is stale, revoked, outside a validity window, or subject to rollback.

Settlement receipts may be generated by a clearing endpoint and appended to the tamper-evident accounting ledger. A settlement receipt can reference payment-versus-payment, delivery-versus-payment, net settlement, exception resolution, escrow release, refund, correction, or recovery events.

Cross-chain deployment may use bridge adapters, oracle adapters, registry adapters, chain-specific token wrappers, or off-chain anchoring. The BEI proof and receipt architecture allows a chain-specific asset to remain tied to a chain-independent identity-root record and policy container.

### ADDITIONAL EXAMPLES OF PRACTICAL APPLICATION

A person registers a personal domain or namespace identifier and binds it to a BEI identity anchor. The system verifies a proof bundle, signs the registration, generates a certificate, stores a signed accounting receipt, and publishes endpoint records for wallet, proof, recovery, and communication services.

A family administrator creates a family namespace node with subordinate child nodes. A policy container defines which family members can update endpoints, request wallet routing, use recovery authority, or receive TimeCurrency-related records under the family node.

An organization registers a root and delegates sub-basepoints to departments or projects. Each sub-basepoint inherits standard privacy, audit, and rollback policies while using separate endpoint records and proof-bundle requirements for its function.

A regional node routes users to local policy, audit, minting, and clearing endpoints. The node may apply jurisdiction-specific privacy rules, verification sources, and financial-service restrictions while preserving a common BEI proof and receipt schema.

An industry node defines authorized proof sources and behavior categories for a sector. A healthcare node, educational node, financial node, communications node, or environmental node can operate with sector-specific endpoint roles and recertification intervals.

Alphabet-based, numeric, or time-based namespaces can support classification, discovery, indexing, or routing. The BEI engine treats such identifiers as identity-root identifiers when they are bound to proofs, policy containers, and endpoint records.

A credential expires under a policy container. The user submits a subsequent proof bundle within a new validity window, and the system generates a subsequent signed accounting receipt that updates the certificate commitment while preserving the prior history.

A user loses control of an endpoint key. A recovery endpoint verifies authority scope, multi-signature conditions, identity-anchor proof, time-window proof, and ledger-state reference before rotating the endpoint key and storing a signed recovery receipt.

A licensor exports selected certificate commitments, endpoint records, policy-version histories, receipts, and ledger-state proofs to a licensee. The export demonstrates technical integration status without disclosing raw personal data or private-key material.

An asset package reviewer verifies that a domain-root identity asset is connected to proof, accounting, endpoint, and rollback layers. The reviewer can evaluate the technical scope of the asset based on machine-verifiable records rather than marketing statements.

### ADDITIONAL TECHNICAL ADVANTAGES

Binding evidence commitments to validity windows, nonces, counters, and prior ledger-state references provides a specific computer mechanism for rejecting stale or duplicated proofs across distributed nodes.

The combination of tokenized identity certificate, signed accounting receipt, and tamper-evident ledger entry provides a traceable history for each critical identity-root state transition.

Signed endpoint records prevent spoofed service endpoints by binding endpoint roles to public keys, policy versions, validity windows, jurisdiction tags, and ledger-state references.

The proof bundle can use commitments and redacted records so that raw biometric data, raw behavior data, and private-key material are not written into broadly visible records.

The rollback architecture allows correction and recovery without arbitrary ledger modification because each rollback is limited by time, authority, proof, state, and policy boundaries.

The policy container and standard-protocol mappings allow the system to connect to wallets, registries, ledgers, clearinghouses, DID-compatible systems, verifiable credentials, and financial-service endpoints.

The architecture is not limited to a single domain system, token standard, ledger, cryptographic algorithm, or endpoint protocol. The critical path is the ordered combination of identity-root commitment, proof bundle, time window, signature, atomic transition, receipt, ledger, endpoint record, and bounded rollback.

Signed receipts and ledger-state proofs can support audit, reconciliation, dispute resolution, regulatory review, recovery, assignment, licensing, and exchange-listing preparation.

### CLAIM SUPPORT AND ANTI-DESIGN-AROUND NARRATIVE

Claim 1 is supported by the ordered method architecture described throughout this specification. The ordered sequence is important because the system does not merely label an identity asset; it verifies a proof bundle, binds evidence to a time window, signs a canonical payload, performs an atomic registration or minting transition, stores a signed receipt in a tamper-evident accounting ledger, and publishes endpoint routing under policy control.

Claim 2 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 3 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 4 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 5 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 6 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 7 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 8 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 9 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 10 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 11 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 12 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 13 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 14 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 15 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 16 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 17 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 18 is supported by the same modules and operations described in system and computer-readable-medium form. The disclosure describes processors, memories, identity-root registries, proof-bundle verification engines, time-window proof modules, signature modules, minting and registration modules, accounting ledger modules, endpoint-record modules, and policy-bounded rollback modules.

Claim 19 is supported by the specific examples, definitions, data fields, state-machine logic, endpoint roles, ledger records, proof sources, policy conditions, privacy safeguards, hardware embodiments, and use cases described above. The dependent claim narrows the root method to a concrete implementation while preserving the broader BEI identity-root architecture.

Claim 20 is supported by the same modules and operations described in system and computer-readable-medium form. The disclosure describes processors, memories, identity-root registries, proof-bundle verification engines, time-window proof modules, signature modules, minting and registration modules, accounting ledger modules, endpoint-record modules, and policy-bounded rollback modules.

Competitors should not be able to avoid the invention merely by renaming a domain root as a namespace, replacing a blockchain with an append-only database, replacing an NFT with a certificate, replacing a certificate with a receipt, replacing a wallet endpoint with a financial-service endpoint, or replacing a rollback with a correction or recovery action. The disclosure uses class terms to preserve broad but technically grounded coverage.

At the same time, the disclosure provides enough implementation detail for enablement. It identifies the required records, modules, state transitions, signatures, proof checks, endpoints, result codes, policy rules, and example fields, allowing a skilled implementer to build a working system using available distributed-system, cryptographic, identity, registry, wallet, and ledger technologies.

### TECHNICAL ADVANTAGES

The disclosed infrastructure reduces identity ambiguity by binding a machine-resolvable identity-root identifier to an identifier commitment, user identity anchor, proof bundle, time-window proof, certificate commitment, signed accounting receipt, ledger-state reference, and signed endpoint record.

The infrastructure improves computer security by using replay-prevention states, proof commitments, BEI signatures, endpoint-record verification, key rotation, challenge-response states, and policy-bounded rollback instead of relying only on static credentials or unbounded identity assertions.

The infrastructure improves auditability by separating tokenized identity certificates, signed accounting receipts, and tamper-evident accounting ledger entries. This separation supports diligence, licensing, transfer, financial-service review, audit, and compliance preparation.

The infrastructure improves privacy by permitting verification using commitments, references, signatures, and redacted proof rather than raw biometric data, raw behavior data, or private-key material.

The infrastructure improves interoperability by defining BEI standard and protocol mappings for identity roots, proof bundles, certificates, receipts, endpoint records, accounting ledgers, and rollback policies.

The infrastructure improves financial-service readiness by providing a bounded rollback mechanism, certificate and receipt artifacts, accounting ledger references, and endpoint records that can be inspected by banks, wallets, exchanges, auditors, and governance reviewers.

### ASSET PACKAGE, TRANSFER, AND LICENSING RELEVANCE

The BEI DomainToken root infrastructure may be licensed or transferred as an identity-root layer for wallets, banks, domain registries, identity platforms, exchanges, healthcare credential systems, education systems, communication systems, tokenized asset platforms, or financial-service endpoints.

Licensing units may include identity-root registration, proof-bundle verification, BEI signature verification, tokenized identity certificate issuance, signed accounting receipt issuance, endpoint-record publication, BEIMINT integration, TimeCurrency integration, financial-service endpoint access, audit export, exchange-listing preparation, or policy-bounded rollback.

The technology can support a layered asset package that includes patents, domain-root assets, standard schemas, APIs, endpoint records, certificates, receipts, accounting ledger structures, wallet integrations, minting endpoints, index inputs, and exchange-listing preparation.

For transaction diligence, the certificate, receipt, ledger, endpoint record, policy container, and proof-bundle commitment provide inspectable artifacts that support valuation, transfer review, license scope definition, integration testing, and audit.

The disclosed infrastructure may serve as a choke-point identity and proof layer for systems that need domain-root identity, behavior proof, time-window verification, financial-service routing, audit, and bounded recovery.

### NO LIMITATION TO SPECIFIC BRANDS OR DOMAINS

The specification identifies BEI, BEIMINT, BEI Currency, TimeCurrency, MF.app, ATMS, BEI index, and exchange-listing preparation as important implementation contexts and asset-package examples.

However, the technical invention is not limited to any one brand, domain name, application domain, or website unless expressly recited in a claim.

A BEI-controlled identity, proof, token, minting, NFT, wallet, currency, index, exchange, audit, recovery, or financial-service endpoint can be implemented through domain names, application domains, mobile endpoints, decentralized identifiers, registry identifiers, or other machine-resolvable namespace identifiers.

This non-limiting approach permits the BEI DomainToken root infrastructure to cover future domain roots, identity roots, app endpoints, and standard-compatible identifiers without requiring repeated amendment of the claims.

Concrete domain names and asset schedules may be maintained in separate asset-package documents, licensing schedules, or continuation applications where appropriate.

The claims should be interpreted according to their technical limitations rather than according to a fixed list of domain names.

### RELATIONSHIP TO DOMAIN-TOKEN ASSET ECOSYSTEM AND EXCHANGE LAYER

The present BEI Domain Token root infrastructure provides an identity, proof, ledger, endpoint, and rollback foundation for domain-tokenized identity assets.

A separate organic domain-token asset ecosystem may generate multiple domain-derived assets, subordinate tokens, multi-layer synergy indices, or GreenMine-style asset pools. The present disclosure can provide identity-root, proof, and endpoint support for such assets.

A separate behavior-indexed exchange or BEI index system may use certificates, receipts, endpoint records, and ledger-state references generated by the present infrastructure for listing preparation, index input, clearing, audit, and governance.

Thus, the present case can operate as a root identity and proof layer within a larger BEI patent family without needing to claim every organic minting or exchange feature in this application.

This layered strategy improves claim clarity because the present claims focus on identity-root, proof bundle, accounting ledger, endpoint routing, and policy-bounded rollback.

The layered strategy also improves licensing because different parties may license the root identity layer, the asset-issuance layer, and the exchange/index layer separately or together.

### CIVILIZATION ECONOMIC VALUE AND PRACTICAL APPLICATION

The BEI infrastructure can support a civilization economic identity layer by giving individuals, families, organizations, industries, regions, and institutions machine-verifiable identity roots tied to behavior, time, proof, receipts, ledgers, and endpoints.

This value is achieved through technical mechanisms rather than unsupported narrative: proof bundles, BEI signatures, time-window proofs, replay-prevention states, accounting receipts, endpoint records, and policy-bounded rollback.

In practical deployment, the system allows a user to convert identity, time, behavior, and domain-root control into auditable participation in wallets, minting systems, financial services, indexes, exchanges, governance systems, and recovery workflows.

The system can support international standard alignment by providing schemas and protocol mappings for identity-root identifiers, proof bundles, certificates, receipts, ledger entries, endpoint records, and rollback policies.

The civilization economic value arises because the infrastructure creates a verifiable bridge between human identity, behavior, time, accountability, and digital economic participation.

### ADDITIONAL IMPLEMENTATION-LEVEL DISCLOSURE FOR 101 AND 112 SUPPORT

The following paragraphs further identify concrete computer operations that may be used in the disclosed BEI infrastructure. The operations are not required to occur in the exact order shown unless expressly recited by a claim. They are provided to show how the modules can be implemented and how the records can be verified by a skilled implementer.

In one implementation, a processor is configured to receive a registration request. The implementation may store an input object, a verification result, a result code, a policy-version identifier, and a ledger-state reference for that operation. By recording these elements, the system provides an auditable machine trail rather than a merely descriptive business record.

In one implementation, a processor is configured to normalize an identity-root identifier. The implementation may store an input object, a verification result, a result code, a policy-version identifier, and a ledger-state reference for that operation. By recording these elements, the system provides an auditable machine trail rather than a merely descriptive business record.

In one implementation, a processor is configured to generate an identifier commitment. The implementation may store an input object, a verification result, a result code, a policy-version identifier, and a ledger-state reference for that operation. By recording these elements, the system provides an auditable machine trail rather than a merely descriptive business record.

In one implementation, a processor is configured to retrieve a policy container. The implementation may store an input object, a verification result, a result code, a policy-version identifier, and a ledger-state reference for that operation. By recording these elements, the system provides an auditable machine trail rather than a merely descriptive business record.

In one implementation, a processor is configured to verify a proof-source key. The implementation may store an input object, a verification result, a result code, a policy-version identifier, and a ledger-state reference for that operation. By recording these elements, the system provides an auditable machine trail rather than a merely descriptive business record.

In one implementation, a processor is configured to verify a proof bundle. The implementation may store an input object, a verification result, a result code, a policy-version identifier, and a ledger-state reference for that operation. By recording these elements, the system provides an auditable machine trail rather than a merely descriptive business record.

In one implementation, a processor is configured to verify a time-window proof. The implementation may store an input object, a verification result, a result code, a policy-version identifier, and a ledger-state reference for that operation. By recording these elements, the system provides an auditable machine trail rather than a merely descriptive business record.

In one implementation, a processor is configured to consume a nonce or counter. The implementation may store an input object, a verification result, a result code, a policy-version identifier, and a ledger-state reference for that operation. By recording these elements, the system provides an auditable machine trail rather than a merely descriptive business record.

In one implementation, a processor is configured to verify a prior ledger-state reference. The implementation may store an input object, a verification result, a result code, a policy-version identifier, and a ledger-state reference for that operation. By recording these elements, the system provides an auditable machine trail rather than a merely descriptive business record.

In one implementation, a processor is configured to generate a BEI signature payload. The implementation may store an input object, a verification result, a result code, a policy-version identifier, and a ledger-state reference for that operation. By recording these elements, the system provides an auditable machine trail rather than a merely descriptive business record.

In one implementation, a processor is configured to execute an atomic bind or mint operation. The implementation may store an input object, a verification result, a result code, a policy-version identifier, and a ledger-state reference for that operation. By recording these elements, the system provides an auditable machine trail rather than a merely descriptive business record.

In one implementation, a processor is configured to generate a tokenized identity certificate. The implementation may store an input object, a verification result, a result code, a policy-version identifier, and a ledger-state reference for that operation. By recording these elements, the system provides an auditable machine trail rather than a merely descriptive business record.

In one implementation, a processor is configured to generate a signed accounting receipt. The implementation may store an input object, a verification result, a result code, a policy-version identifier, and a ledger-state reference for that operation. By recording these elements, the system provides an auditable machine trail rather than a merely descriptive business record.

In one implementation, a processor is configured to append a ledger entry. The implementation may store an input object, a verification result, a result code, a policy-version identifier, and a ledger-state reference for that operation. By recording these elements, the system provides an auditable machine trail rather than a merely descriptive business record.

In one implementation, a processor is configured to publish a signed endpoint record. The implementation may store an input object, a verification result, a result code, a policy-version identifier, and a ledger-state reference for that operation. By recording these elements, the system provides an auditable machine trail rather than a merely descriptive business record.

In one implementation, a processor is configured to evaluate rollback boundaries. The implementation may store an input object, a verification result, a result code, a policy-version identifier, and a ledger-state reference for that operation. By recording these elements, the system provides an auditable machine trail rather than a merely descriptive business record.

In one implementation, a processor is configured to execute a bounded recovery operation. The implementation may store an input object, a verification result, a result code, a policy-version identifier, and a ledger-state reference for that operation. By recording these elements, the system provides an auditable machine trail rather than a merely descriptive business record.

In one implementation, a processor is configured to export an audit package. The implementation may store an input object, a verification result, a result code, a policy-version identifier, and a ledger-state reference for that operation. By recording these elements, the system provides an auditable machine trail rather than a merely descriptive business record.

### NON-LIMITING PSEUDOCODE-STYLE VERIFICATION EXAMPLE

A verification routine may begin by canonicalizing the identity-root identifier and computing an identifier commitment. If the identifier has already been registered in a conflicting state, the routine returns a duplicate-root result code and prevents an atomic minting transition.

The routine may then load the policy container effective for the requested endpoint role and time-window. If the requested proof source, endpoint role, behavior category, jurisdiction, or identity-root class is not authorized by the policy container, the routine returns a policy-denied result code.

The routine may verify the proof-source signature and the BEI identity-anchor signature. If either signature is invalid, revoked, outside a key-rotation validity window, or inconsistent with the endpoint record, the routine returns a signature-denied result code.

The routine may verify the time-window proof by comparing the evidence commitment, nonce, counter, session state, source timestamp, and prior ledger-state reference against the replay-prevention state machine. If the proof is stale, duplicated, or outside the validity window, the routine returns a replay-denied result code.

If the foregoing checks succeed, the routine may compute a certificate commitment, generate a signed accounting receipt, append a ledger entry, update an endpoint record, and return an approved state. These steps may be executed within a transaction boundary so that partial registration, partial minting, or partial endpoint activation cannot occur.

### NON-LIMITING RECORD SCHEMAS AND FIELD RELATIONSHIPS

A IdentityRootRecord may include one or more of the following fields: identityRootID, rootType, normalizedIdentifier, identifierCommitment, ownerAnchorRef, parentRootRef, policy Version, status, createdWindow, lastReceiptRef. These fields illustrate a concrete data structure for implementing the corresponding module and may be stored as JSON, XML, binary objects, relational records, smart-contract objects, or ledger events.

The IdentityRootRecord may include a hash or commitment over selected fields so that later validators can detect unauthorized modification. The record may also include redaction flags or references to controlled-access evidence repositories when raw evidence is not stored in the ledger.

A ProofBundleRecord may include one or more of the following fields: proofBundleID, identityRootID, proofTypes, evidenceCommitments, sourceIDs, sourceSignatures, timeWindow, nonce, counter, privacyFlags, ledgerStateRef. These fields illustrate a concrete data structure for implementing the corresponding module and may be stored as JSON, XML, binary objects, relational records, smart-contract objects, or ledger events.

The ProofBundleRecord may include a hash or commitment over selected fields so that later validators can detect unauthorized modification. The record may also include redaction flags or references to controlled-access evidence repositories when raw evidence is not stored in the ledger.

A EndpointRecord may include one or more of the following fields: endpointRecordID, identityRootID, role, address, publicKeyRef, validity Window, policy Version, jurisdiction, revocationStatus, failoverRef, signature. These fields illustrate a concrete data structure for implementing the corresponding module and may be stored as JSON, XML, binary objects, relational records, smart-contract objects, or ledger events.

The EndpointRecord may include a hash or commitment over selected fields so that later validators can detect unauthorized modification. The record may also include redaction flags or references to controlled-access evidence repositories when raw evidence is not stored in the ledger.

A CertificateRecord may include one or more of the following fields: certificateID, tokenizedIdentity AssetID, identifierCommitmentRef, identity AnchorRef, proofBundleCommitment, time Window, policy Version, ledgerStateRef, status, signature. These fields illustrate a concrete data structure for implementing the corresponding module and may be stored as JSON, XML, binary objects, relational records, smart-contract objects, or ledger events.

The CertificateRecord may include a hash or commitment over selected fields so that later validators can detect unauthorized modification. The record may also include redaction flags or references to controlled-access evidence repositories when raw evidence is not stored in the ledger.

A RollbackRecord may include one or more of the following fields: rollbackID, requestedState, priorStateRef, rollback Window, authority Scope, proofRequirement, reasonCode, resultingState, receiptRef, signature. These fields illustrate a concrete data structure for implementing the corresponding module and may be stored as JSON, XML, binary objects, relational records, smart-contract objects, or ledger events.

The RollbackRecord may include a hash or commitment over selected fields so that later validators can detect unauthorized modification. The record may also include redaction flags or references to controlled-access evidence repositories when raw evidence is not stored in the ledger.

### FIGURE-TO-SPECIFICATION SUPPORT MAPPING

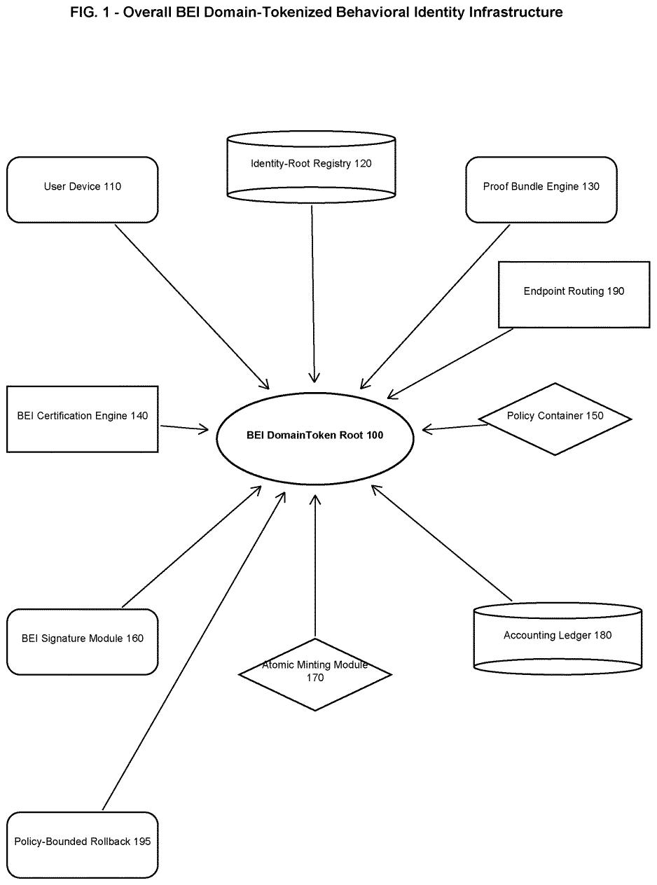

FIG. 1 provides visual support for the overall BEI domain-tokenized behavioral identity infrastructure. The corresponding text describes the modules, records, and state transitions shown in the figure so that the figure is not merely decorative but is tied to specific claim elements and implementation details.

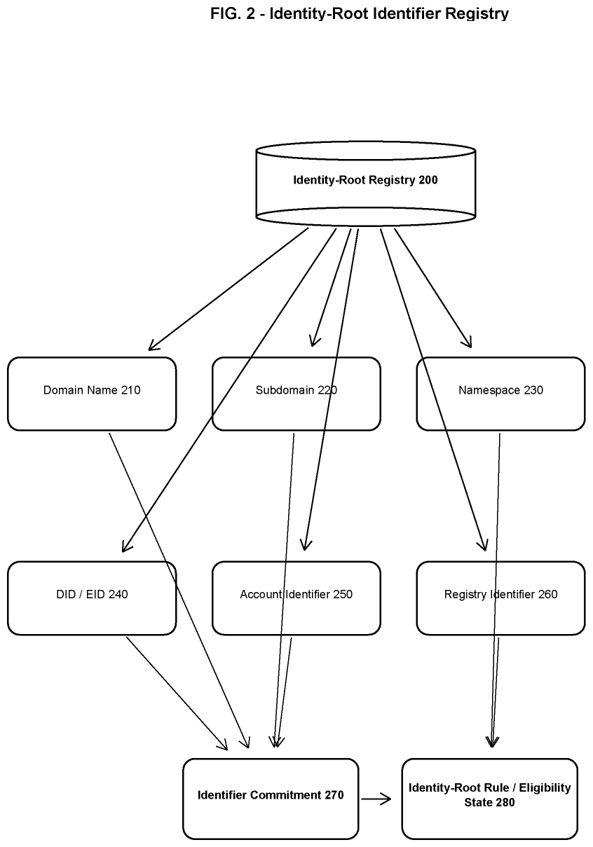

FIG. 2 provides visual support for the identity-root identifier registry and root eligibility checks. The corresponding text describes the modules, records, and state transitions shown in the figure so that the figure is not merely decorative but is tied to specific claim elements and implementation details.

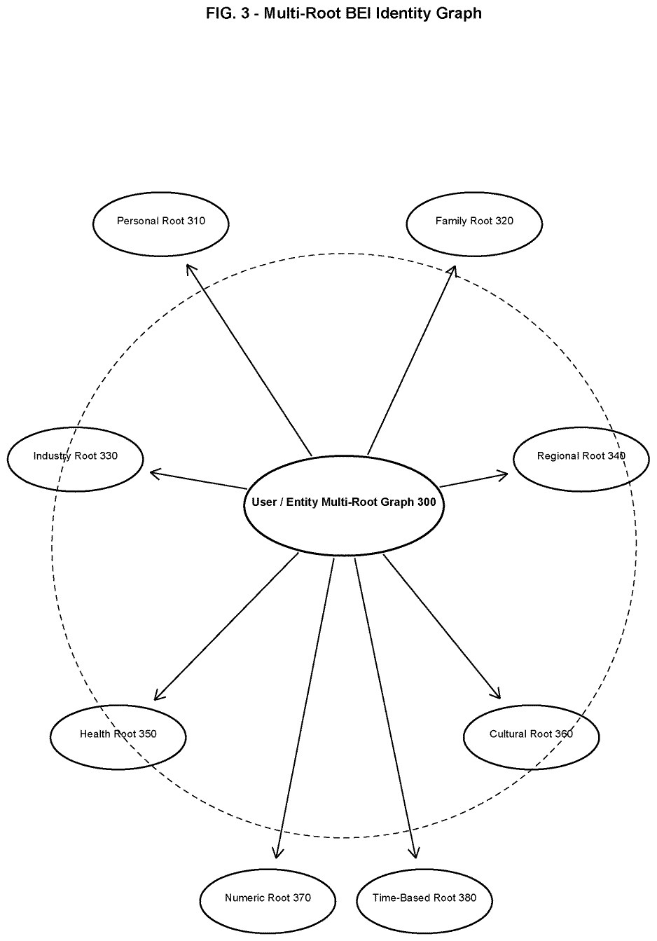

FIG. 3 provides visual support for the multi-root BEI identity graph for personal, family, organization, region, industry, culture, health, numeric, and time roots. The corresponding text describes the modules, records, and state transitions shown in the figure so that the figure is not merely decorative but is tied to specific claim elements and implementation details.

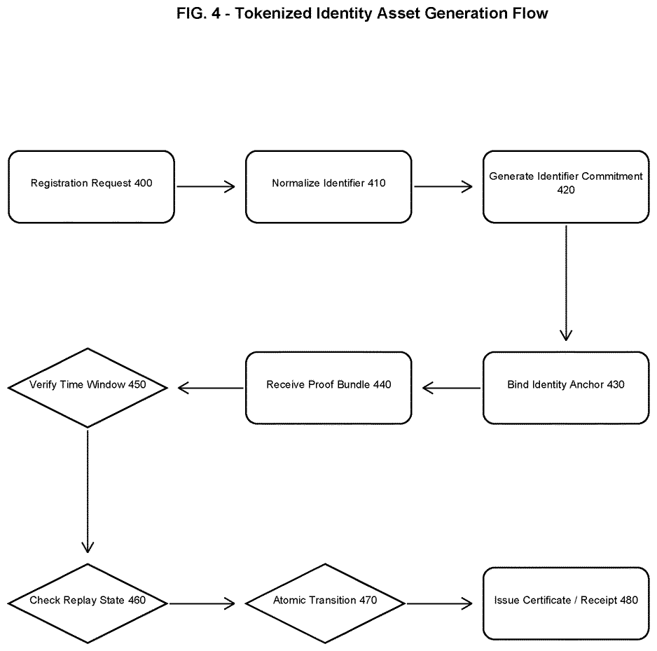

FIG. 4 provides visual support for the tokenized identity asset generation from registration request through certificate and receipt output. The corresponding text describes the modules, records, and state transitions shown in the figure so that the figure is not merely decorative but is tied to specific claim elements and implementation details.

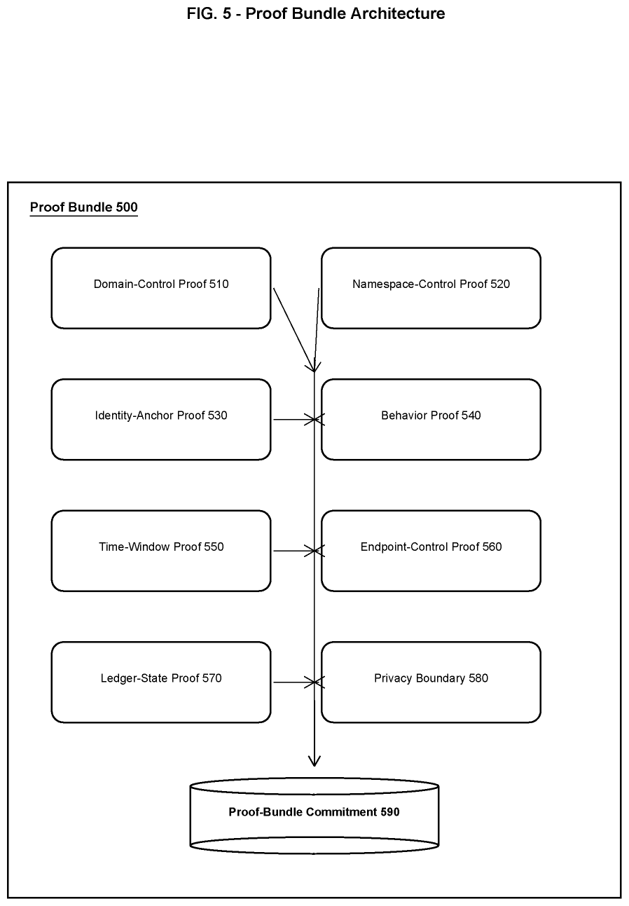

FIG. 5 provides visual support for the proof bundle architecture and evidence commitments. The corresponding text describes the modules, records, and state transitions shown in the figure so that the figure is not merely decorative but is tied to specific claim elements and implementation details.

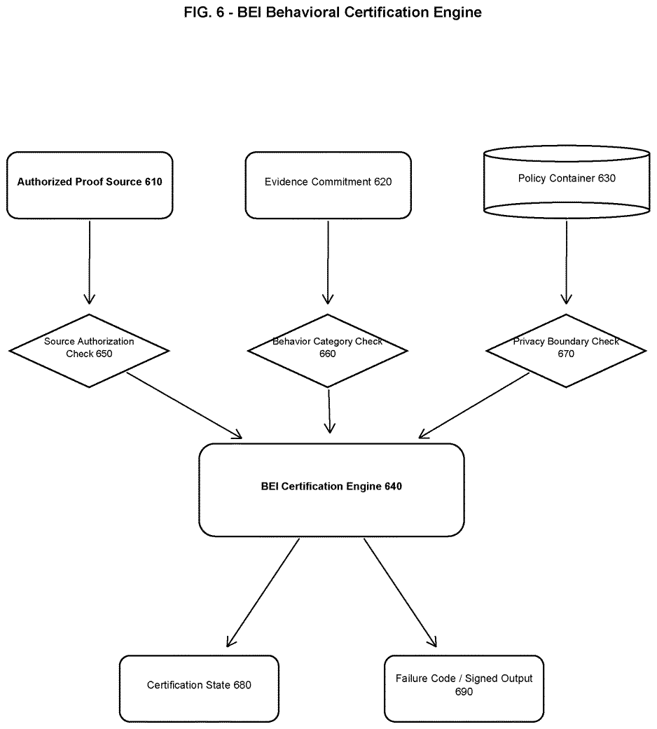

FIG. 6 provides visual support for the BEI behavioral certification engine and policy verification. The corresponding text describes the modules, records, and state transitions shown in the figure so that the figure is not merely decorative but is tied to specific claim elements and implementation details.

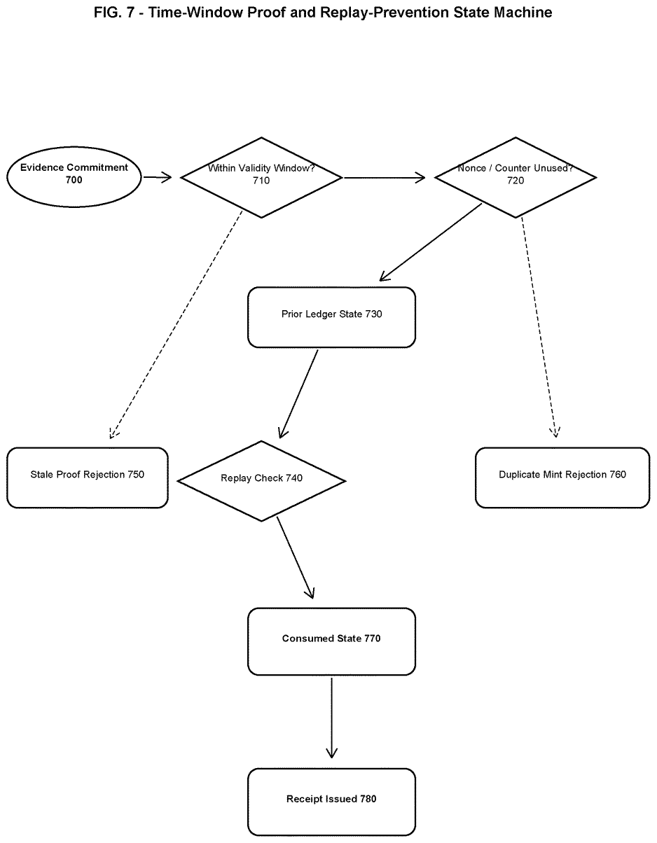

FIG. 7 provides visual support for the time-window proof and replay-prevention state machine. The corresponding text describes the modules, records, and state transitions shown in the figure so that the figure is not merely decorative but is tied to specific claim elements and implementation details.

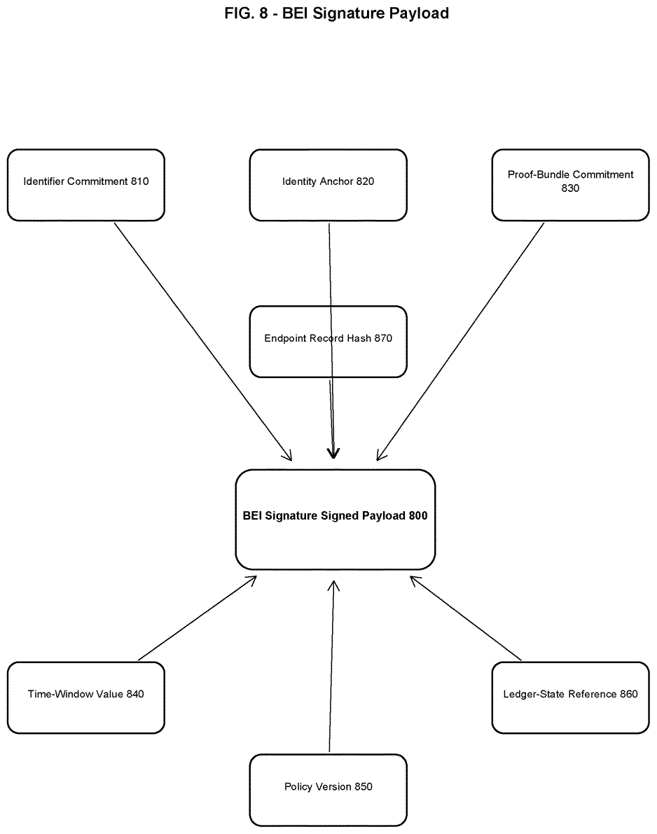

FIG. 8 provides visual support for the BEI signature payload and canonical signing fields. The corresponding text describes the modules, records, and state transitions shown in the figure so that the figure is not merely decorative but is tied to specific claim elements and implementation details.

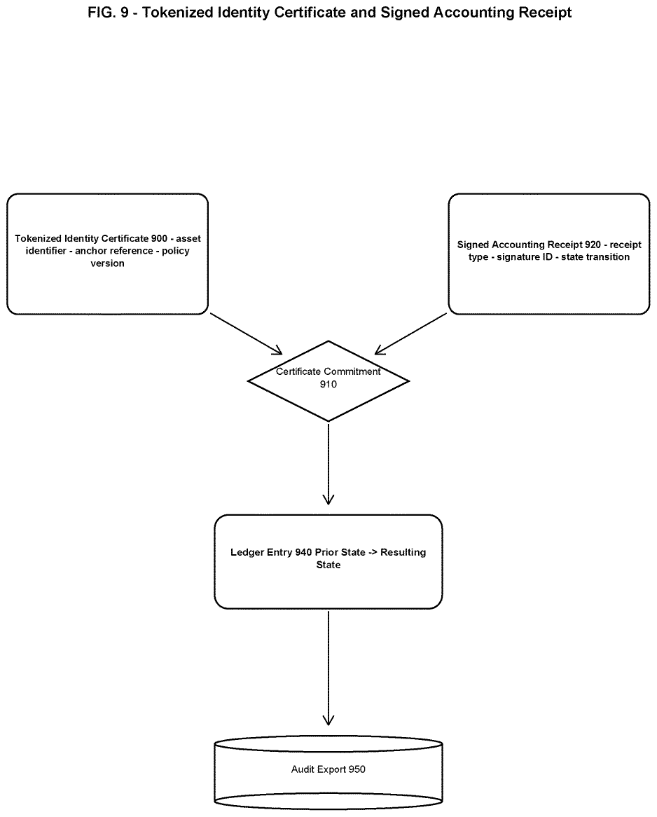

FIG. 9 provides visual support for the tokenized identity certificate and signed accounting receipt structures. The corresponding text describes the modules, records, and state transitions shown in the figure so that the figure is not merely decorative but is tied to specific claim elements and implementation details.

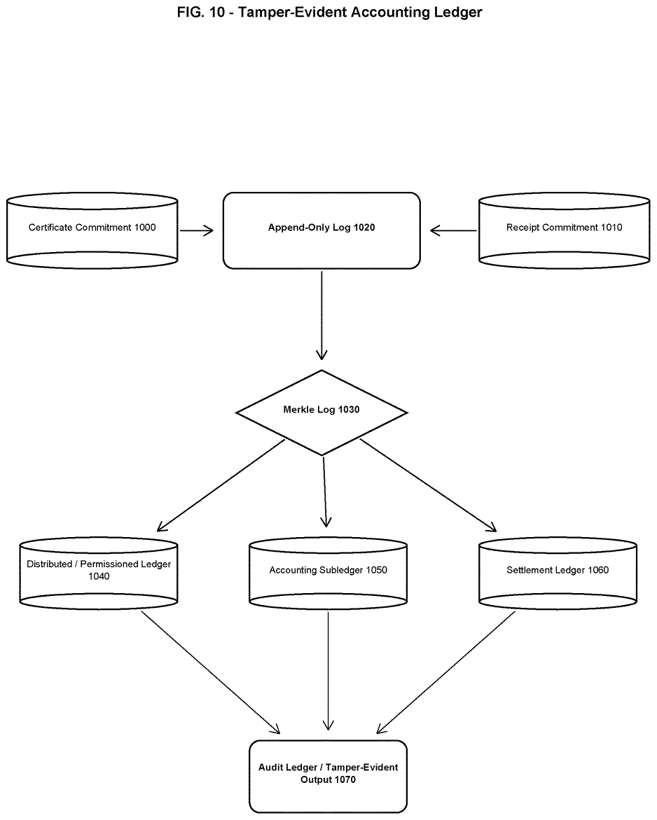

FIG. 10 provides visual support for the tamper-evident accounting ledger and receipt chain. The corresponding text describes the modules, records, and state transitions shown in the figure so that the figure is not merely decorative but is tied to specific claim elements and implementation details.

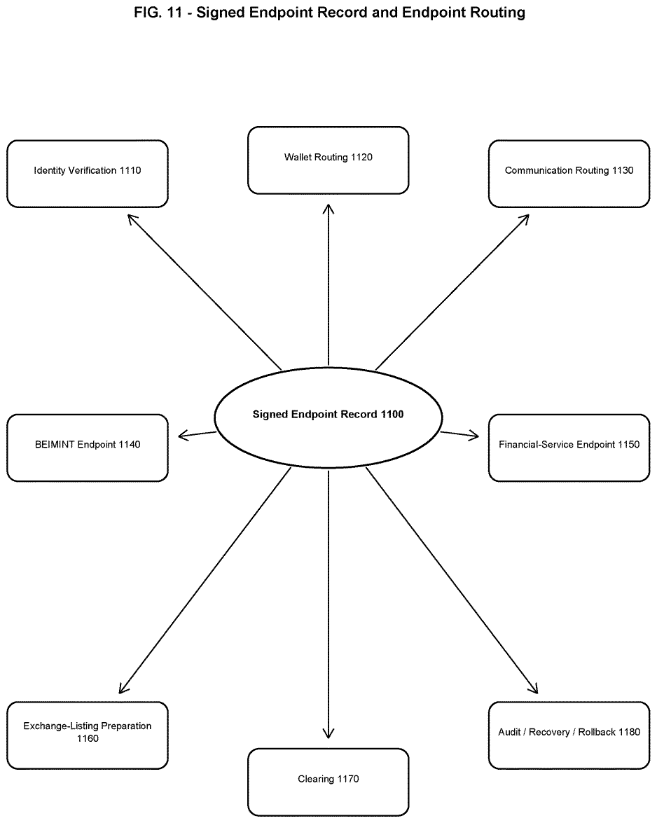

FIG. 11 provides visual support for the signed endpoint record and endpoint routing roles. The corresponding text describes the modules, records, and state transitions shown in the figure so that the figure is not merely decorative but is tied to specific claim elements and implementation details.

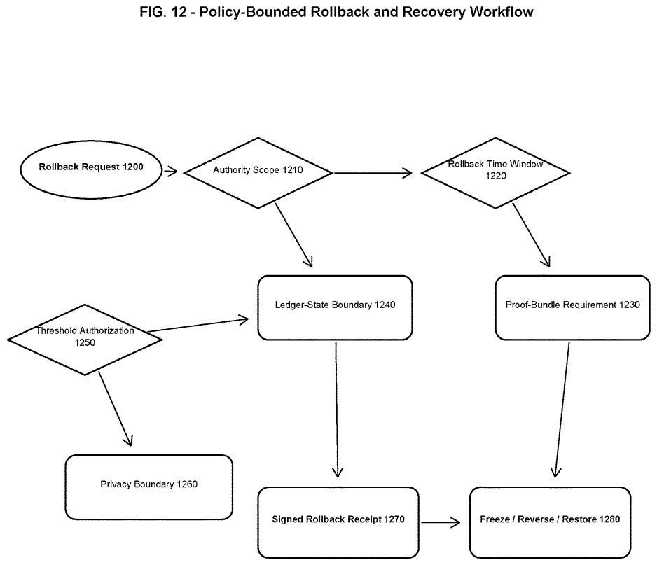

FIG. 12 provides visual support for the policy-bounded rollback and recovery workflow. The corresponding text describes the modules, records, and state transitions shown in the figure so that the figure is not merely decorative but is tied to specific claim elements and implementation details.

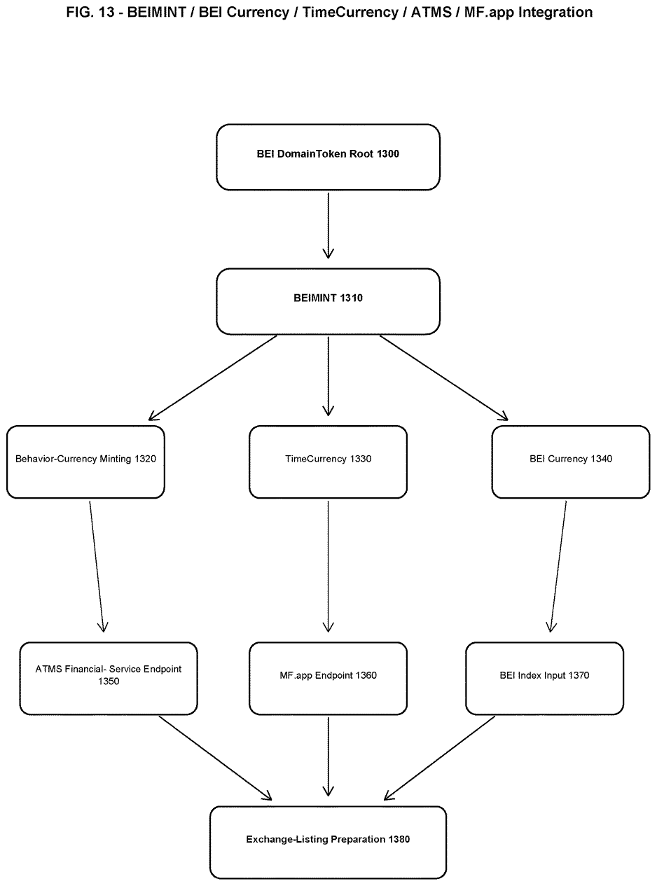

FIG. 13 provides visual support for the BEIMINT, BEI Currency, TimeCurrency, ATMS, and MF.app integration. The corresponding text describes the modules, records, and state transitions shown in the figure so that the figure is not merely decorative but is tied to specific claim elements and implementation details.

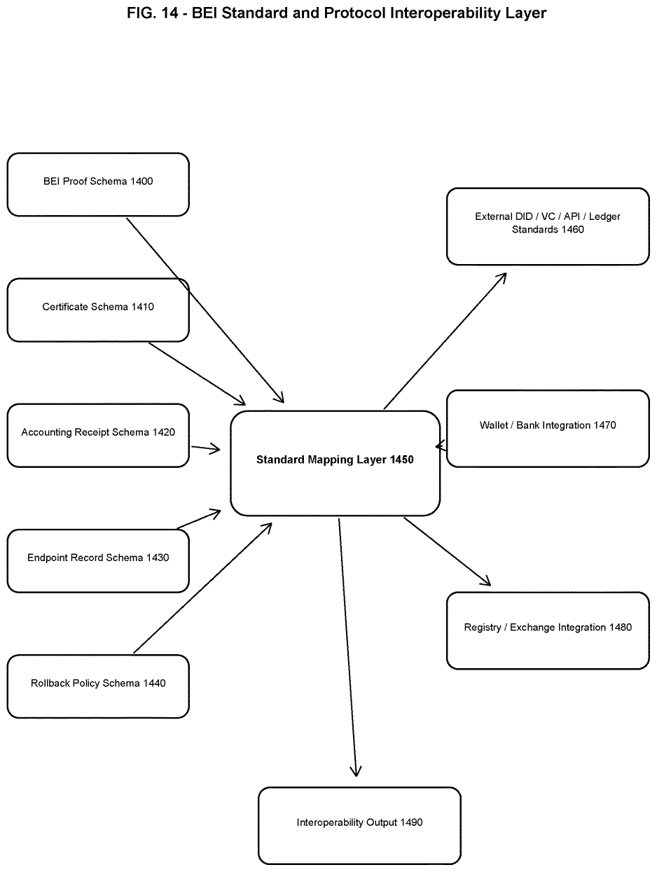

FIG. 14 provides visual support for the BEI standard and protocol interoperability layer. The corresponding text describes the modules, records, and state transitions shown in the figure so that the figure is not merely decorative but is tied to specific claim elements and implementation details.

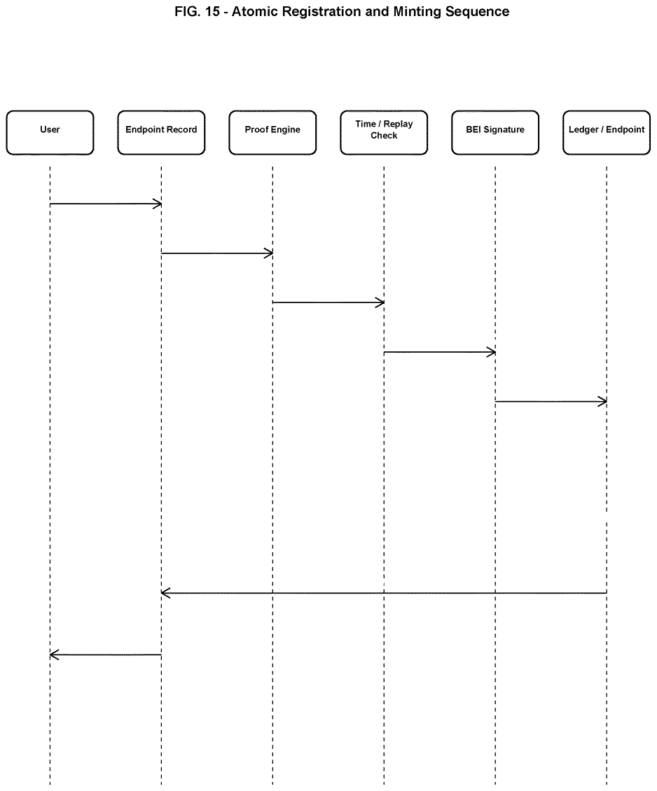

FIG. 15 provides visual support for the atomic sequence from request through ledger anchoring and endpoint routing. The corresponding text describes the modules, records, and state transitions shown in the figure so that the figure is not merely decorative but is tied to specific claim elements and implementation details.

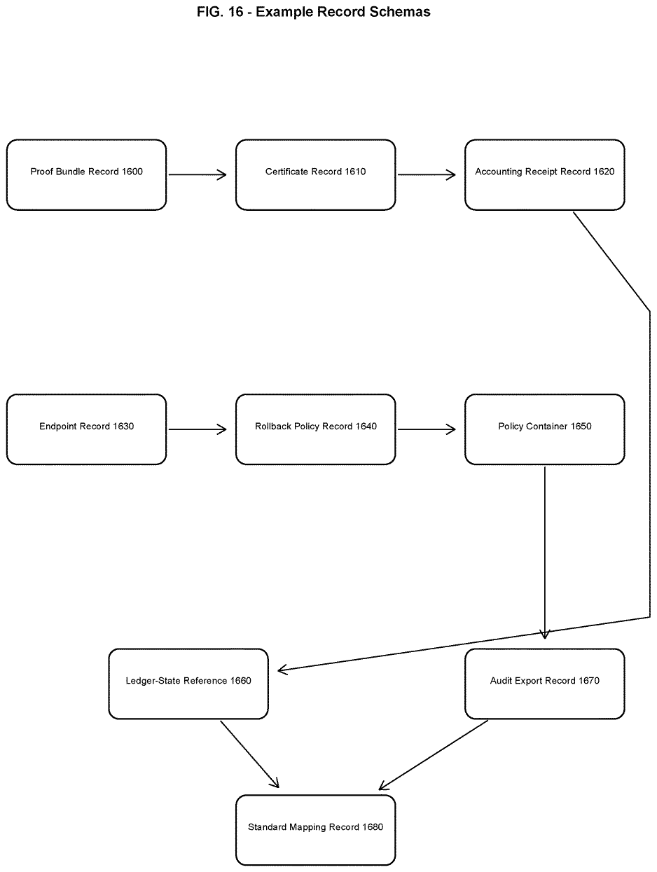

FIG. 16 provides visual support for the record schemas and cross-reference relationships among proof, certificate, receipt, ledger, endpoint, and rollback objects. The corresponding text describes the modules, records, and state transitions shown in the figure so that the figure is not merely decorative but is tied to specific claim elements and implementation details.

### EXAMINER-ORIENTED TECHNICAL PROBLEM AND SOLUTION STATEMENTS

With respect to identity-root ambiguity, the disclosed infrastructure provides a technical solution. The system solves identity-root ambiguity by creating an identifier commitment and binding it to a user identity anchor, proof bundle, certificate, signed receipt, ledger-state reference, and endpoint record.

With respect to stale proof replay, the disclosed infrastructure provides a technical solution. The system solves stale proof replay by using a validity window, nonce, counter, one-time evidence commitment, source signature, and prior ledger-state reference before permitting an atomic state transition.

With respect to endpoint spoofing, the disclosed infrastructure provides a technical solution. The system solves endpoint spoofing by requiring signed endpoint records, public key references, validity windows, revocation states, failover records, and policy-version identifiers.

With respect to unbounded reversal risk, the disclosed infrastructure provides a technical solution. The system solves unbounded reversal risk by making rollback a policy-bounded state transition constrained by time, authority, proof, ledger state, reason code, and signed receipt generation.

With respect to privacy exposure, the disclosed infrastructure provides a technical solution. The system solves privacy exposure by recording commitments, redacted proof states, encrypted references, or zero-knowledge proof references rather than forcing raw biometric or behavior records into broadly visible ledger entries.

With respect to asset diligence uncertainty, the disclosed infrastructure provides a technical solution. The system solves asset diligence uncertainty by producing certificates, signed receipts, ledger entries, endpoint records, and audit exports that can be independently verified by licensees, assignees, auditors, or financial-service integrators.

### ADDITIONAL ASSET-PACKAGE AND LICENSING IMPLEMENTATION EXAMPLES

A domain registry licensee may implement the identity-root registry and endpoint-record module while relying on a BEI behavioral certification engine operated by another provider. The signed accounting receipt links the registry operation to the proof and ledger state.

A wallet licensee may implement wallet routing, communication routing, and recovery endpoints while using existing proof-bundle verification APIs. The wallet can reject stale endpoint records and require recertification before activating financial-service functions.

A bank or financial-service licensee may implement ATMS-style financial-service endpoints using the tokenized identity certificate and signed accounting receipt as onboarding and audit objects. The licensee can perform its own compliance checks through the policy container while maintaining BEI proof compatibility.

An exchange or clearing licensee may use the exchange-listing preparation endpoint to verify whether a BEI identity-root asset or value unit is eligible for listing, clearing, matching, netting, reconciliation, or settlement. The endpoint can require that no unresolved rollback state exists.

A healthcare, education, or professional credential licensee may operate as an authorized proof source. The licensee signs behavior or credential records, while the BEI engine converts them into proof-bundle commitments and audit-ready receipts.

A standards or certification body may publish policy containers and standard-protocol mappings. Implementers can certify that their endpoints produce compatible proof bundles, certificates, accounting receipts, ledger entries, and rollback receipts.

### NON-LIMITING COMMERCIAL AND CIVILIZATION-SCALE DEPLOYMENT CONTEXT

The disclosed invention can be deployed in a civilization-scale environment because the identity-root identifier is not limited to one domain, one account, one country, one chain, one bank, or one platform. A population-scale deployment may use many domain roots, namespace roots, sub-basepoints, endpoint roles, and policy containers while preserving the same proof, signature, receipt, ledger, and rollback semantics.

Although the system may support commercial assignment, licensing, transfer, standards certification, asset-package diligence, or financial-service integration, those uses are examples of industrial applicability. The technical invention remains the ordered BEI identity-root proof, signature, ledger, endpoint, and rollback infrastructure described in this specification.

The practical effect of the architecture is that human-readable identity-root resources can become machine-verifiable trust roots for behavior, time, proof, currency, wallet, audit, recovery, and clearing functions. This is not achieved by merely displaying a domain name; it is achieved by the specific combination of commitments, proofs, signatures, receipts, ledger state, endpoint records, and policy boundaries.

### ADDITIONAL PROSECUTION-READY IMPLEMENTATION VARIANTS

The BEI infrastructure may be implemented as a modular service stack in which the identity-root registry, proof-bundle verification engine, signature module, accounting ledger module, endpoint-record module, and rollback module are independently scalable services communicating through signed API payloads.

The same infrastructure may also be implemented as a smart-contract-centered stack in which one or more contracts maintain identifier commitments, consumed nonce states, certificate commitments, receipt hashes, endpoint-record hashes, and rollback states while private evidence remains off-chain.

A hybrid implementation may place high-frequency verification and privacy-sensitive evidence in permissioned services while anchoring only commitments, result codes, and ledger-state references in a public or shared tamper-evident data structure.

An offline or intermittently connected implementation may permit a device or institution to sign a provisional proof bundle and later submit the bundle to a BEI endpoint when connectivity returns. The endpoint may accept the bundle only if the validity window, nonce, counter, and policy-version rules are satisfied.

A high-assurance implementation may require a hardware secure element, institutional attestor, or threshold group of verifiers before a financial-service endpoint, exchange-listing endpoint, or rollback endpoint is activated.

A low-friction implementation may permit a namespace or wallet endpoint to operate with lighter proof requirements while preventing minting, clearing, transfer preparation, or exchange-listing operations until stronger proof sources are verified.

The system may maintain a distinction between an identity-root active state, an endpoint-active state, a minting-enabled state, a clearing-eligible state, and a rollback-restricted state. This distinction permits fine-grained control instead of a single all-or-nothing account status.

The system may use a policy-status vector indicating whether identity, proof, minting, wallet, audit, exchange, clearing, governance, and recovery endpoint roles are enabled, disabled, restricted, pending, or frozen. The vector may be signed and included in the certificate or endpoint record.

When a user selects multiple identity roots, the multi-root identity graph may compute a permitted presentation set for a transaction. For example, a health endpoint may require a medical or professional root, whereas a family wallet endpoint may require a family root and a personal identity anchor.

When the same evidence could support different endpoint roles, the policy container can require role-specific commitments so that evidence used for one purpose cannot be automatically replayed for another purpose without a separate consent, time-window proof, and signed receipt.

An auditor may verify a chain of records by starting from a tokenized identity asset identifier, retrieving the certificate commitment, locating the signed accounting receipt, validating the receipt signature, checking the ledger-state reference, and resolving the current signed endpoint record.

A licensee may verify technology transfer by confirming that the delivered implementation can generate proof-bundle records, tokenized identity certificates, signed accounting receipts, ledger entries, endpoint records, and policy-bounded rollback receipts using the schemas described in this specification.

A financial-service integrator may require that every high-risk operation produce at least two artifacts: a user-facing certificate or status object and a machine-facing signed accounting receipt. The certificate supports presentation, while the receipt supports audit, reconciliation, and dispute resolution.

An exchange-listing integrator may require that every listing candidate have a current certificate, no expired proof-bundle state, no unresolved rollback pending state, a valid endpoint record, and a clear ledger-state proof showing that the asset was registered or minted under a current policy container.

A standards integrator may map the BEI proof-bundle schema to multiple external identity or credential formats while preserving the critical fields of identifier commitment, identity-anchor reference, evidence commitment, time-window value, policy-version identifier, and ledger-state reference.

A court, regulator, or designated institutional reviewer may receive a privacy-preserving audit package that proves compliance with a policy container without publishing raw biometric data, raw behavior data, raw personal documents, or private-key material.

A recovery authority may operate under a narrow authority scope that permits key rotation or endpoint restoration but does not permit currency minting, clearing, or exchange-listing approval. This separation of authority reduces operational risk.

A governance authority may update future policy containers but may be prevented from altering historical receipts, prior certificate commitments, consumed nonces, or prior ledger-state references. This preserves historical auditability while permitting prospective rule changes.

A recertification engine may periodically request updated proof bundles from authorized proof sources. If recertification is not completed within a defined interval, the system may restrict selected endpoint roles while leaving historical ledger records intact.

A subordinate identity node may inherit policy defaults from a parent domain root while having its own endpoint record, proof-bundle requirements, certificate commitment, receipt chain, and rollback boundary. This supports scalable subdomain and sub-namespace expansion.

In a chip-like or fragment-like subdivision embodiment, a root identifier may generate many scoped child identifiers. Each child identifier may have a separate endpoint role, policy container reference, ledger-state reference, and accounting receipt chain, while remaining discoverable under the parent root.

In a civilization-scale embodiment, the same technical primitives can support personal, family, institutional, regional, industrial, medical, educational, financial, cultural, numeric, and time-based nodes. The scale is enabled by routable endpoint records and policy containers, not by manual account administration.

The disclosed implementation therefore provides a hard technical gate. A downstream system seeking to rely on BEI identity, behavior proof, minting, financial-service routing, clearing, index input, or bounded recovery must pass through the proof, signature, ledger, endpoint, and policy-boundary checks described herein.

This gate is useful for licensing and assignment because it provides objective, machine-verifiable integration points. A transferee or licensee can inspect whether an implementation performs the required checks and whether the generated receipts and endpoint records conform to the BEI data model.

The gate is useful for examination because it ties the alleged invention to specific computer operations, including commitment generation, signature verification, state-machine transition, nonce consumption, ledger anchoring, endpoint resolution, and rollback-boundary enforcement.

### INDUSTRIAL APPLICABILITY

The disclosure is applicable to digital identity, domain registries, namespace systems, wallets, financial services, bank-grade account systems, communication endpoints, behavior-currency systems, TimeCurrency systems, BEI Currency systems, healthcare identity, education credentials, professional credentials, governance systems, audit systems, and exchange-listing preparation.

The disclosure may be implemented in software, hardware, firmware, secure elements, cloud services, distributed ledger networks, permissioned ledgers, public blockchains, private databases, append-only logs, message queues, stream processors, wallet applications, financial-service endpoints, domain registries, identity-provider systems, or hybrid systems.

The invention provides a machine-verifiable identity-root infrastructure for converting human identity, time, behavior, domain-root control, proof commitments, policy-bounded accountability, and endpoint routing into auditable digital economic participation.

What is claimed is:

1. A computer-implemented method for generating and managing a BEI behavior-certified tokenized identity asset, comprising:
receiving, by one or more processors, a registration request associated with a human-readable domain identifier, namespace identifier, decentralized identity identifier, registry identifier, account identifier, or other machine-resolvable identity-root identifier;
generating a tokenized identity asset identifier from at least an identifier commitment corresponding to the identity-root identifier a user identity anchor and a time-window value;
receiving a proof bundle associated with a user, the proof bundle including at least one evidence commitment derived from a domain-control proof, namespace-control proof, identity-anchor proof, behavior proof, time-window proof, endpoint-control proof, or ledger-state proof;
verifying, by a BEI behavioral certification engine, the proof bundle against a policy container that defines at least one authorized proof source, at least one eligible behavior category, at least one validity window, and at least one identity-root rule;
generating or verifying a time-window proof that binds the evidence commitment to the validity window and to a replay-prevention state;
generating, by a BEI signature module, a cryptographic signature over at least the identifier commitment, the user identity anchor, the proof bundle, the time-window value, a policy-version identifier, and a ledger-state reference;
executing an atomic registration or minting transition that verifies, binds, registers, or mints the tokenized identity asset identifier to the user identity anchor;
generating a tokenized identity certificate, a signed accounting receipt, and a ledger entry corresponding to the atomic registration or minting transition;
storing the signed accounting receipt and a certificate commitment in a tamper-evident accounting ledger; and
publishing or updating a signed endpoint record configured to route the BEI behavior-certified tokenized identity asset to at least one identity, wallet, communication, minting, financial-service, exchange-listing, clearing, audit, governance, recovery, or policy-bounded rollback endpoint.

2. The method of claim 1, wherein the identity-root identifier comprises a domain name. subdomain, personal namespace, family namespace, organization namespace, country or regional namespace, industry namespace, cultural namespace, medical or health namespace, alphabet-based namespace, numeric namespace, time-based namespace, decentralized identifier, electronic identity identifier, or standardized digital identity identifier.

3. The method of claim 1, wherein the identifier commitment comprises a hash commitment, Merkle commitment, signed endpoint-record commitment, registry-record commitment, namespace commitment, or cryptographic commitment corresponding to the identity-root identifier.

4. The method of claim 1, wherein the user identity anchor comprises a decentralized identifier, electronic identity identifier, verifiable credential reference, account-bound token, non-transferable identity token, biometric credential reference, public key, wallet address, domain-token identity root, or multi-root identity graph node.

5. The method of claim 1, wherein the authorized proof source comprises a user device, biometric sensor, geolocation sensor, hardware secure element, trusted execution environment, institutional attestor, software agent, Internet-of-Things device, medical device, educational platform, employer system, financial platform, registry service, domain service, identity service, or threshold group of verifiers.

6. The method of claim 1, wherein the proof bundle includes at least one biometric proof, location proof, time-engagement proof, interaction proof, health behavior proof, education behavior proof, work behavior proof, environmental behavior proof, payment behavior proof, domain-control proof, namespace-control proof, social attestation proof, institutional attestation proof, endpoint-control proof, ledger-state proof, or privacy-preserving proof.

7. The method of claim 1, wherein the replay-prevention state comprises a nonce, counter, one-time evidence commitment, time-window uniqueness constraint, device-session state, rate-limit state, prior ledger-state reference, duplicate-mint rejection state, or challenge-response state.

8. The method of claim 1, wherein the policy container includes eligible behavior categories, authorized source identifiers, jurisdictional rules, regulatory rules, standard-protocol mappings, transfer restrictions, minting caps, recertification intervals, anomaly thresholds, freeze conditions, recovery conditions, authority-scope rules, privacy-boundary rules, or policy-bounded rollback conditions.

9. The method of claim 1, wherein the tokenized identity certificate includes the tokenized identity asset identifier, an identifier commitment reference, an identity-anchor reference, a proof-bundle commitment, a time-window value, a policy-version identifier, a signature identifier, a ledger-state reference, a certificate status, and a certificate commitment.

10. The method of claim 1, wherein the tamper-evident accounting ledger comprises a distributed ledger, permissioned ledger, append-only log, Merkle log, timestamped receipt chain, write-once storage, cryptographically auditable database, accounting subledger, settlement ledger, or audit ledger.

11. The method of claim 1, wherein the signed endpoint record identifies at least one endpoint role selected from identity verification, proof verification, policy retrieval, wallet routing, communication routing, behavior-currency minting, TimeCurrency minting, BEI currency minting, financial-service access, exchange listing, clearing, audit, governance, recovery, or policy-bounded rollback.

12. The method of claim 11, wherein the signed endpoint record includes an endpoint address public key, policy-version identifier, validity window, jurisdiction identifier, revocation status, key-rotation indicator, endpoint priority, endpoint role, failover endpoint, or external-standard mapping.

13. The method of claim 1, further comprising periodically recertifying the BEI behavior-certified tokenized identity asset by receiving a subsequent proof bundle, verifying a subsequent time-window proof, generating a subsequent signed accounting receipt, and appending the subsequent signed accounting receipt to the tamper-evident accounting ledger.

14. The method of claim 1, further comprising applying a policy-bounded rollback operation to a tokenized identity asset state transition, wherein the policy-bounded rollback operation is limited by a rollback time window, authority scope, ledger-state reference, transaction amount, token-state type, nonce, counter, proof-bundle requirement, policy-version identifier, privacy boundary, or threshold authorization rule.

15. The method of claim 14, wherein the policy-bounded rollback operation generates a signed rollback receipt and updates a token state to frozen, restricted, reversed, revoked, restored, corrected, or recovered according to the policy container.

16. The method of claim 14, wherein the policy-bounded rollback operation verifies a rollback proof without exposing raw biometric data, raw behavior data, private-key material, or unredacted personally identifiable information.

17. The method of claim 1, wherein the BEI behavior-certified tokenized identity asset is used as an identity key for a digital wallet, namespace routing, Web3 navigation, messaging, voice communication, payment initiation, BEIMINT operation, behavior-currency minting, TimeCurrency minting, BEI currency minting, ATMS financial-service endpoint, MF.app endpoint, BEI index input, or exchange-listing preparation.

18. A BEI behavior-certified tokenized identity infrastructure system, comprising:
one or more processors; and
one or more memories storing instructions that, when executed by the one or more processors, cause the system to provide:
an identity-root registry configured to store domain identifiers, namespace identifiers, decentralized identity identifiers, registry identifiers, account identifiers, or other machine-resolvable identity-root identifiers;
a tokenized identity asset generator configured to generate a tokenized identity asset identifier from an identifier commitment, a user identity anchor, and a time-window value;
a proof-bundle verification engine configured to verify proof bundles from authorized proof sources under a policy container;
a time-window proof module configured to bind an evidence commitment to a validity window and a replay-prevention state;
a BEI signature module configured to generate or verify a cryptographic signature over the identifier commitment, the user identity anchor, the proof bundle, the time-window value, a policy-version identifier, and a ledger-state reference;
a minting and registration module configured to execute an atomic registration or minting transition that verifies, binds, registers, or mints the tokenized identity asset identifier to the user identity anchor;
an accounting ledger module configured to generate a tokenized identity certificate, signed accounting receipt, certificate commitment, and ledger entry;
an endpoint-record module configured to publish or verify signed endpoint records for identity, wallet, communication, minting, financial-service, exchange-listing, clearing, audit, governance, recovery, or rollback endpoints; and
a policy-bounded rollback module configured to freeze, restrict, reverse, restore, correct, or recover a tokenized identity asset state transition according to a rollback time window, authority scope, proof-bundle requirement, and ledger-state reference.

19. The system of claim 18, wherein the policy container is configured as a BEI standardization and protocol layer that maps identity-root rules, proof-source rules, endpoint-role rules, jurisdictional rules, accounting-ledger rules, rollback rules, privacy rules, authority-scope rules, and interoperability rules to one or more BEI identity, BEI currency, TimeCurrency, BEIMINT, ATMS, MF.app, BEI index, or exchange-listing implementations.

20. A non-transitory computer-readable medium storing instructions that, when executed by one or more processors, cause the one or more processors to perform operations comprising:
receiving a registration request associated with a domain identifier, namespace identifier, decentralized identity identifier, registry identifier, account identifier, or other machine-resolvable identity-root identifier; generating a tokenized identity asset identifier from an identifier commitment, user identity anchor, and time-window value; receiving and verifying a proof bundle under a policy container using a BEI behavioral certification engine; generating or verifying a time-window proof associated with a replay-prevention state; signing a payload comprising the identifier commitment, user identity anchor, proof-bundle commitment, time-window value, policy-version identifier, and ledger-state reference; executing an atomic registration or minting transition that verifies, binds, registers, or mints the tokenized identity asset identifier to the user identity anchor; generating a tokenized identity certificate, signed accounting receipt, certificate commitment, and ledger entry; storing the signed accounting receipt and certificate commitment in a tamper-evident accounting ledger; publishing or updating a signed endpoint record; and executing a policy-bounded rollback operation when a rollback request satisfies a rollback time window, authority scope, proof-bundle requirement, privacy boundary, and ledger-state reference.
